(19) United States
(12) Patent Application Publication
(10) Pub. No.: US 2024/0348090 A1
(43) Pub. Date: Oct. 17, 2024

(54) PROVIDING POWER TO DEVICES FROM A MAGNETOELECTRIC ENERGY HARVESTER

(71) Applicant: Toyota Motor Engineering & Manufacturing North America, Inc., Plano, TX (US)

(72) Inventors: Shailesh N. Joshi, Ann Arbor, MI (US); Hiroshi Ukegawa, South Lyon, MI (US); Jae Seung Lee, Ann Arbor, MI (US); Ercan Mehmet Dede, Ann Arbor, MI (US)

(21) Appl. No.: 18/133,231

(22) Filed: Apr. 11, 2023

(51) Int. Cl. H02J 50/00; H02J 3/38; H02N 11/00

(52) U.S. Cl. CPC H02J 50/001; H02J 3/381; H02N 11/002; H02J 7/32

(57) ABSTRACT

A system for providing power to devices from a magnetoelectric energy harvester can include a processor and a memory. The memory can store a rate analysis module and a controller module. The rate analysis module can include instructions that cause the processor to determine a rate at which an energy storage device bank stores energy received from a magnetoelectric energy harvester. The controller module can include instructions that cause the processor to cause, in response to an existence of a condition and the rate being: (1) greater than a power consumption rate of a first device, the first device to receive power from the energy storage device bank and (2) greater than a power consumption rate of a second device, but less than the power consumption rate of the first device, the second device to receive the power from the energy storage device bank.

### TECHNICAL FIELD

The disclosed technologies are directed to providing power to devices from a magnetoelectric energy harvester.

### BACKGROUND

A sensor can produce an output signal in response to a detection of a physical phenomenon. A sensor can be used to obtain information about an environment. In certain implementations, a sensor can be used to obtain information related to an operating condition of a machine. A sensor can include, for example, a sensing component, a processing component, a communications component, and a power component. The sensor can be a device that includes one or more of the sensing component, the processing component, the communications component, or the power component. Alternatively, the sensor can be a system in which one or more of the sensing component can be a sensing device, the processing component can be a processing device, the communications component can be a communications device, or the power component can be a power device. Often, one or more cables can be used to connect the communications component to a system configured to use the information obtained by the sensor, connect the power component to an energy source, or both. A use of such one or more cables can complicate efforts to have a sensor disposed at an optimal location within an environment from which information can be sought to be obtained. Using a wireless communications component in a sensor can remove a need to use one or more cables to connect the sensor to a system configured to use the information obtained by the sensor. Additionally, using an energy harvester may improve an ability for a sensor to operate without using one or more cables to connect the sensor to an energy source.

### SUMMARY

In an embodiment, a system for providing power to devices from a magnetoelectric energy harvester can include a processor and a memory. The memory can store a rate analysis module and a controller module. The rate analysis module can include instructions that, when executed by the processor, cause the processor to determine a rate at which an energy storage device bank stores energy received from a magnetoelectric energy harvester. The controller module can include instructions that, when executed by the processor, cause the processor to cause, in response to an existence of a condition and the rate being: (1) greater than a power consumption rate of a first device, the first device to receive power from the energy storage device bank and (2) greater than a power consumption rate of a second device, but less than the power consumption rate of the first device, the second device to receive the power from the energy storage device bank.

In another embodiment, a method for providing power to devices from a magnetoelectric energy harvester can include determining, by a processor, a rate at which an energy storage device bank stores energy received from the magnetoelectric energy harvester. The method can include causing, by the processor, in response to an existence of a condition and the rate being: (1) greater than a power consumption rate of a first device, the first device to receive the power from the energy storage device bank and (2) greater than a power consumption rate of a second device, but less than the power consumption rate of the first device, the second device to receive the power from the energy storage device bank.

In another embodiment, a non-transitory computer-readable medium for providing power to devices from a magnetoelectric energy harvester can include instructions that, when executed by one or more processors, cause the one or more processors to determine a rate at which an energy storage device bank stores energy received from the magnetoelectric energy harvester. The non-transitory computer-readable medium can include instructions that, when executed by one or more processors, cause the one or more processors to cause, in response to an existence of a condition and the rate being: (1) greater than a power consumption rate of a first device, the first device to receive power from the energy storage device bank and (2) greater than a power consumption rate of a second device, but less than the power consumption rate of the first device, the second device to receive the power from the energy storage device bank.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of a magnetoelectric energy harvester, according to the disclosed technologies.

FIG. 2 includes a diagram that illustrates an example of an energy storage device bank, according to the disclosed technologies.

FIG. 3 includes a block diagram that illustrates an example of a system for providing power to devices from the magnetoelectric energy harvester, according to the disclosed technologies.

FIG. 4 includes a table that illustrates sources of power for a first device and a second device as a function of a rate at which the energy storage device bank stores energy received from the magnetoelectric energy harvester, according to the disclosed technologies.

FIG. 5 includes a diagram that illustrates an example of a magnetoelectric energy transmitter, according to the disclosed technologies.

FIG. 6 includes a diagram that illustrates an example of a magnetoelectric energy receiver, according to the disclosed technologies.

FIG. 7 includes a diagram that illustrates an example of an environment for providing power to devices from a magnetoelectric energy harvester, according to the disclosed technologies.

FIG. 8 includes a diagram that illustrates an example of a vehicle configured to provide power to devices from a magnetoelectric energy harvester, according to the disclosed technologies.

FIG. 9 includes a flow diagram that illustrates an example of a method that is associated with storing energy, received from a magnetoelectric energy harvester, in an energy storage device bank, according to the disclosed technologies.

FIGS. 10A through 10C include a flow diagram that illustrates an example of a method that is associated with providing power to devices from a magnetoelectric energy harvester, according to the disclosed technologies.

FIG. 11 includes a flow diagram that illustrates an example of a first method that is associated with determining a degree of deterioration of an electric motor, according to the disclosed technologies.

FIG. 12 includes a flow diagram that illustrates an example of a second method that is associated with determining the degree of deterioration of the electric motor, according to the disclosed technologies.

FIG. 13 includes a flow diagram that illustrates an example of a method that is associated with determining a degree of deterioration of a power field-effect transistor, according to the disclosed technologies.

FIG. 14 includes a flow diagram that illustrates an example of the method that is associated with managing a storage of energy between an energy source and an energy storage device bank, according to the disclosed technologies.

FIG. 15 includes a block diagram that illustrates an example of elements disposed on a vehicle, according to the disclosed technologies.

### DETAILED DESCRIPTION

The disclosed technologies are directed to providing power to devices from a magnetoelectric energy harvester. An energy storage device bank can include, for example, a plurality of energy storage devices. For example, an energy storage device, of the energy storage device bank, can include one or more of a battery, a capacitor, a supercapacitor, or the like. A first energy storage device, of the energy storage device bank, can be caused to be configured to store energy received from a magnetoelectric energy harvester. A determination can be made that an amount of energy stored by the first energy storage device is near a capacity of the first energy storage device. In response to a determination that the amount of energy stored by the first energy storage device is near the capacity of the first energy storage device: (1) a second energy storage device, of the energy storage device bank, can be caused to be configured to store the energy received from the magnetoelectric energy harvester and (2) the first energy storage device can be caused to be configured to cease storing the energy received from the magnetoelectric energy harvester. In this manner, the energy received from the magnetoelectric energy harvester can be stored in the energy storage device bank.

A rate at which the energy storage device bank stores energy received from the magnetoelectric energy harvester can be determined. In response to the rate being greater than a power consumption rate of a first device, the first device can be caused to receive the power from the energy storage device bank. In response to the rate being greater than a power consumption rate of a second device, but less than the power consumption rate of the first device, the second device can be caused to receive the power from the energy storage device bank. Additionally, for example, in response to the rate being less than the power consumption rate of the second device: (1) the first device can be caused to receive power from an energy source and (2) the second device can be caused to receive the power from the energy source. Additionally, for example, in response to the rate being greater than the power consumption rate of the first device, the second device can be caused to receive power from the energy source. Additionally, for example, in response to the rate being greater than the power consumption rate of the second device, but less than the power consumption rate of the first device, the first device can be caused to receive power from the energy source. Additionally, for example, in response to the rate being greater than a sum of the power consumption rate of the first device and the power consumption rate of the second device: (1) the first device can be caused to receive the power from the energy storage device bank and (2) the second device can be caused to receive the power from the energy storage device bank. In this manner, use of the energy source to provide power to one or more of the first device or the second device can be minimized so that an amount of energy available from the energy source can be preserved.

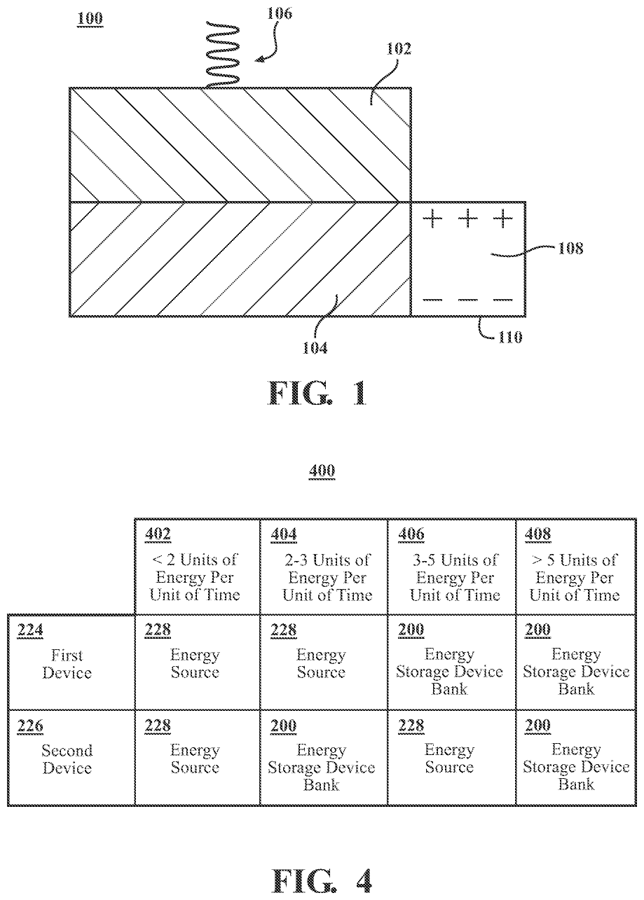

FIG. 1 includes a diagram that illustrates an example of a magnetoelectric energy harvester 100, according to the disclosed technologies. The magnetoelectric energy harvester 100 can include, for example, a magnetostriction layer 102 and a piezoelectric layer 104. The magnetostriction layer 102 can be coupled to the piezoelectric layer 104. The magnetostriction layer 102 can be configured so that, in response to being in a presence of a varying magnetic field 106 (e.g., produced by a nearby transmission of electric power in an alternating current form, a wireless communication of a radio frequency signal, or the like), the magnetostriction layer 102 can change shape. Because the piezoelectric layer 104 is coupled to the magnetostriction layer 102, a change in shape of the magnetostriction layer 102 can cause a change in shape of the piezoelectric layer 104. The piezoelectric layer 104 can be configured so that, in response to a change in shape of the piezoelectric layer 104, the piezoelectric layer 104 can produce an electric potential 108 that can be stored, in an energy storage device 110, as electrical energy.

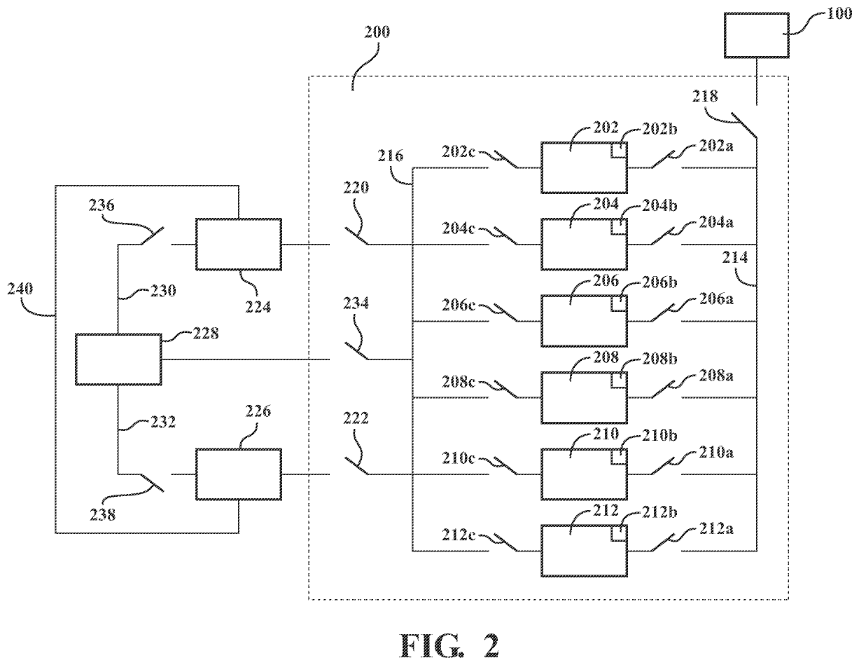

FIG. 2 includes a diagram that illustrates an example of an energy storage device bank 200, according to the disclosed technologies. The energy storage device bank 200 can include, for example, a first energy storage device 202, a second energy storage device 204, a third energy storage device 206, a fourth energy storage device 208, a fifth energy storage device 210, a sixth energy storage device 212, a first conductor 214, and a second conductor 216. For example, one or more of the first energy storage device 202, the second energy storage device 204, the third energy storage device 206, the fourth energy storage device 208, the fifth energy storage device 210, the sixth energy storage device 212 can include one or more of a battery, a capacitor, a supercapacitor, or the like.

The energy storage device bank 200 can include, for example, a first switch 202a, a second switch 204a, a third switch 206a, a fourth switch 208a, a fifth switch 210a, a sixth switch 212a, and a seventh switch 218. For example, the first switch 202a can be configured to connect the first energy storage device 202 to the first conductor 214, the second switch 204a can be configured to connect the second energy storage device 204 to the first conductor 214, the third switch 206a can be configured to connect the third energy storage device 206 to the first conductor 214, the fourth switch 208a can be configured to connect the fourth energy storage device 208 to the first conductor 214, the fifth switch 210a can be configured to connect the fifth energy storage device 210 to the first conductor 214, the sixth switch 212a can be configured to connect the sixth energy storage device 212 to the first conductor 214, and the seventh switch 218 can be configured to connect the first conductor 214 to the magnetoelectric energy harvester 100 in an environment of the energy storage device bank 200.

The energy storage device bank 200 can include, for example, a first sensor 202b, a second sensor 204b, a third sensor 206b, a fourth sensor 208b, a fifth sensor 210b, and a sixth sensor 212b. For example, the first sensor 202b can be configured to sense an amount of energy stored by the first energy storage device 202, the second sensor 204b can be configured to sense an amount of energy stored by the second energy storage device 204, the third sensor 206b can be configured to sense an amount of energy stored by the third energy storage device 206, the fourth sensor 208b can be configured to sense an amount of energy stored by the fourth energy storage device 208, the fifth sensor 210b can be configured to sense an amount of energy stored by the fifth energy storage device 210, and the sixth sensor 212b can be configured to sense an amount of energy stored by the sixth energy storage device 212.

For example, in response to the first sensor 202b sensing that the amount of energy stored by the first energy storage device 202 is less than a capacity of the first energy storage device 202, the first switch 202a can be closed so that the first energy storage device 202 can be configured to store energy received from the magnetoelectric energy harvester 100.

For example, in response to: (1) the first sensor 202b sensing that the amount of energy stored by the first energy storage device 202 is at the capacity of the first energy storage device 202 and (2) the second sensor 204b sensing that the amount of energy stored by the second energy storage device 204 is less than a capacity of the second energy storage device 204: (1) the second switch 204a can be closed so that the second energy storage device 204 can be configured to store energy received from the magnetoelectric energy harvester 100 and (2) the first switch 202a can be opened so that the first energy storage device 202 can be configured to cease storing energy received from the magnetoelectric energy harvester 100.

For example, in response to: (1) the second sensor 204b sensing that the amount of energy stored by the second energy storage device 204 is at the capacity of the second energy storage device 204 and (2) the third sensor 206b sensing that the amount of energy stored by the third energy storage device 206 is less than a capacity of the third energy storage device 206: (1) the third switch 206a can be closed so that the third energy storage device 206 can be configured to store energy received from the magnetoelectric energy harvester 100 and (2) the second switch 204a can be opened so that the second energy storage device 204 can be configured to cease storing energy received from the magnetoelectric energy harvester 100.

For example, in response to: (1) the third sensor 206b sensing that the amount of energy stored by the third energy storage device 206 is at the capacity of the third energy storage device 206 and (2) the fourth sensor 208b sensing that the amount of energy stored by the fourth energy storage device 208 is less than a capacity of the fourth energy storage device 208: (1) the fourth switch 208a can be closed so that the fourth energy storage device 208 can be configured to store energy received from the magnetoelectric energy harvester 100 and (2) the third switch 206a can be opened so that the third energy storage device 206 can be configured to cease storing energy received from the magnetoelectric energy harvester 100.

For example, in response to: (1) the fourth sensor 208b sensing that the amount of energy stored by the fourth energy storage device 208 is at the capacity of the fourth energy storage device 208 and (2) the fifth sensor 210b sensing that the amount of energy stored by the fifth energy storage device 210 is less than a capacity of the fifth energy storage device 210: (1) the fifth switch 210a can be closed so that the fifth energy storage device 210 can be configured to store energy received from the magnetoelectric energy harvester 100 and (2) the fourth switch 208a can be opened so that the fourth energy storage device 208 can be configured to cease storing energy received from the magnetoelectric energy harvester 100.

For example, in response to: (1) the fifth sensor 210b sensing that the amount of energy stored by the fifth energy storage device 210 is at the capacity of the fifth energy storage device 210 and (2) the sixth sensor 212b sensing that the amount of energy stored by the sixth energy storage device 212 is less than a capacity of the sixth energy storage device 212: (1) the sixth switch 212a can be closed so that the sixth energy storage device 212 can be configured to store energy received from the magnetoelectric energy harvester 100 and (2) the fifth switch 210a can be opened so that the fifth energy storage device 210 can be configured to cease storing energy received from the magnetoelectric energy harvester 100.

For example, in response to: (1) the sixth sensor 212b sensing that the amount of energy stored by the sixth energy storage device 212 is at the capacity of the sixth energy storage device 212 and (2) the first sensor 202b sensing that the amount of energy stored by the first energy storage device 202 is less than a capacity of the first energy storage device 202: (1) the first switch 202a can be closed so that the first energy storage device 202 can be configured to store energy received from the magnetoelectric energy harvester 100 and (2) the sixth switch 212a can be opened so that the sixth energy storage device 212 can be configured to cease storing energy received from the magnetoelectric energy harvester 100.

The energy storage device bank 200 can include, for example, an eighth switch 202c, a ninth switch 204c, a tenth switch 206c, an eleventh switch 208c, a twelfth switch 210c, and a thirteenth switch 212c. For example, the eighth switch 202c can be configured to connect the first energy storage device 202 to the second conductor 216, the ninth switch 204c can be configured to connect the second energy storage device 204 to the second conductor 216, the tenth switch 206c can be configured to connect the third energy storage device 206 to the second conductor 216, the eleventh switch 208c can be configured to connect the fourth energy storage device 208 to the second conductor 216, the twelfth switch 210c can be configured to connect the fifth energy storage device 210 to the second conductor 216, and the thirteenth switch 212c can be configured to connect the sixth energy storage device 212 to the second conductor 216.

The energy storage device bank 200 can include, for example, a fourteenth switch 220, a fifteenth switch 222, and a sixteenth switch 234. For example, the fourteenth switch 220 can be configured to connect the second conductor 216 to a first device 224 in the environment of the energy storage device bank 200 and the fifteenth switch 222 can be configured to connect the second conductor 216 to a second device 226 in the environment of the energy storage device bank 200. For example, the sixteenth switch 234 can be configured to connect an energy source 228 to the second conductor 216. For example, the energy source 228 can include one or more of a battery, a fuel cell, a capacitor, a supercapacitor, a transmission line, or the like.

The environment of the energy storage device bank 200 can include, for example, the energy source 228, a third conductor 230, a fourth conductor 232, a seventeenth switch 236, and an eighteenth switch 238. For example, the third conductor 230 can be connected to the energy source 228 and the fourth conductor 232 can be connected to the energy source 228. For example, the seventeenth switch 236 can be configured to connect the first device 224 to the third conductor 230 and the eighteenth switch 238 can be configured to connect the second device 226 to the fourth conductor 232.

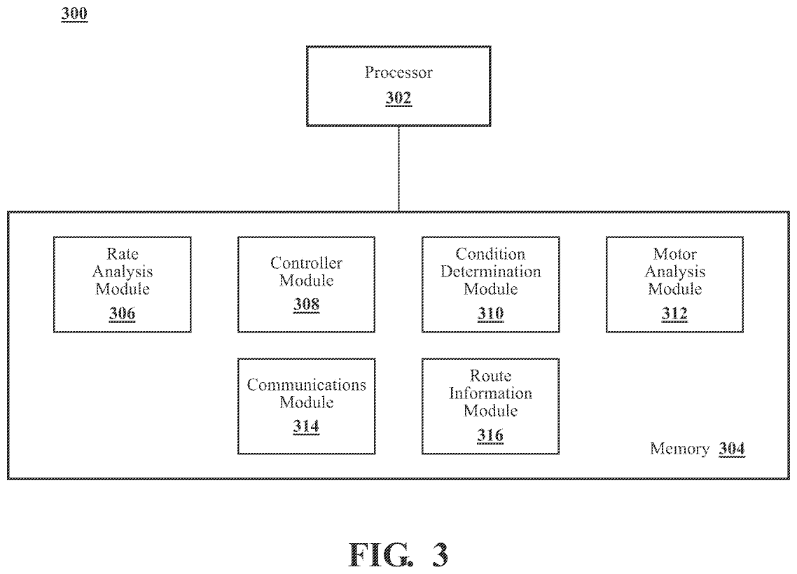

FIG. 3 includes a block diagram that illustrates an example of a system 300 for providing power to devices from a magnetoelectric energy harvester, according to the disclosed technologies. The system 300 can include, for example, a processor 302 and a memory 304. The memory 304 can be communicably connected to the processor 302. For example, the memory 304 can store a rate analysis module 306 and a controller module 308.

For example, the rate analysis module 306 can include instructions that function to control the processor 302 to determine a rate at which an energy storage device bank stores energy received from the magnetoelectric energy harvester. For example, the magnetoelectric energy harvester can be the magnetoelectric energy harvester 100 illustrated in FIG. 1. For example, the energy storage device bank can be the energy storage device bank 200 illustrated in FIG. 2. For example, each of the first energy storage device 202, the second energy storage device 204, the third energy storage device 206, the fourth energy storage device 208, the fifth energy storage device 210, and the sixth energy storage device 212 illustrated in FIG. 2 can be configured to store one unit of energy.

For example, the controller module 308 can include instructions that function to control the processor 302 to cause, in response to: (1) an existence of a condition and (2) the rate at which the energy storage device bank stores energy received from the magnetoelectric energy harvester being greater than a power consumption rate of a first device, the first device to receive the power from the energy storage device bank. In general, the condition can be any condition. With reference to FIG. 2, for example, if: (1) the power consumption rate of the first device 224 is three units of energy per unit of time and (2) the rate at which the energy storage device bank 200 stores energy from the magnetoelectric energy harvester 100 is greater than three units of energy per unit of time, then each of the eighth switch 202c, the ninth switch 204c, the tenth switch 206c, the eleventh switch 208c, the twelfth switch 210c, the thirteenth switch 212c, and the fourteenth switch 220 can be closed in a manner so that the first device 224 can be configured to receive power from the energy storage device bank 200.

Returning to FIG. 3, for example, the controller module 308 can include instructions that function to control the processor 302 to cause, in response to: (1) the existence of the condition and (2) the rate at which the energy storage device bank stores energy received from the magnetoelectric energy harvester being greater than a power consumption rate of a second device, but less than the power consumption rate of the first device, the second device to receive the power from the energy storage device bank. In general, the condition can be any condition. With reference to FIG. 2, for example, if: (1) the power consumption rate of the second device 226 is two units of energy per unit of time and (2) the rate at which the energy storage device bank 200 stores energy from the magnetoelectric energy harvester 100 is greater than two units of energy per unit of time, but less than three units of energy per unit of time, then each of the eighth switch 202c, the ninth switch 204c, the tenth switch 206c, the eleventh switch 208c, the twelfth switch 210c, the thirteenth switch 212c, and the fifteenth switch 222 can be closed in a manner so that the second device 226 can be configured to receive power from the energy storage device bank 200.

Returning to FIG. 3, additionally, for example, the controller module 308 can further include instructions that function to control the processor 302 to cause, in response to the rate at which the energy storage device bank stores energy received from the magnetoelectric energy harvester being less than the power consumption rate of the second device: (1) the first device to receive power from an energy source and (2) the second device to receive the power from the energy source. With reference to FIG. 2, for example, the energy source can be the energy source 228 and if the rate at which the energy storage device bank 200 stores energy from the magnetoelectric energy harvester 100 is less than two units of energy per unit of time, then each of the sixteenth switch 234 and the seventeenth switch 236 can be closed in a manner so that both of the first device 224 and the second device 226 can be configured to receive power from the energy source 228.

Returning to FIG. 3, additionally, for example, the controller module 308 can further include instructions that function to control the processor 302 to cause, in response to the rate at which the energy storage device bank stores energy received from the magnetoelectric energy harvester being greater than the power consumption rate of the first device, the second device to receive the power from the energy source. With reference to FIG. 2, for example, the energy source can be the energy source 228 and if the rate at which the energy storage device bank 200 stores energy from the magnetoelectric energy harvester 100 is greater than two units of energy per unit of time, then the seventeenth switch 236 can be closed in a manner so that the second device 226 can be configured to receive power from the energy source 228.

Returning to FIG. 3, additionally, for example, the controller module 308 can further include instructions that function to control the processor 302 to cause, in response to the rate at which the energy storage device bank stores energy received from the magnetoelectric energy harvester being greater than the power consumption rate of the second device, but less than the power consumption rate of the first device, the first device to receive power from the energy source. With reference to FIG. 2, for example, if the rate at which the energy storage device bank 200 stores energy from the magnetoelectric energy harvester 100 is greater than two units of energy per unit of time, but less than three units of energy per unit of time, then the sixteenth switch 234 can be closed in a manner so that the first device 224 can be configured to receive power from the energy source 228.

Returning to FIG. 3, additionally, for example, the controller module 308 can further include instructions that function to control the processor 302 to cause, in response to the rate at which the energy storage device bank stores energy received from the magnetoelectric energy harvester being greater than a sum of the power consumption rate of the first device and the power consumption rate of the second device: (1) the first device to receive the power from the energy storage device bank and (2) the second device to receive the power from the energy storage device bank. With reference to FIG. 2, for example, if the rate at which the energy storage device bank 200 stores energy from the magnetoelectric energy harvester 100 is greater than five units of energy per unit of time, then each of the eighth switch 202c, the ninth switch 204c, the tenth switch 206c, the eleventh switch 208c, the twelfth switch 210c, the thirteenth switch 212c, the fourteenth switch 220, and the fifteenth switch 222 can be closed in a manner so that both the first device 224 and the second device 226 can be configured to receive power from the energy storage device bank 200.

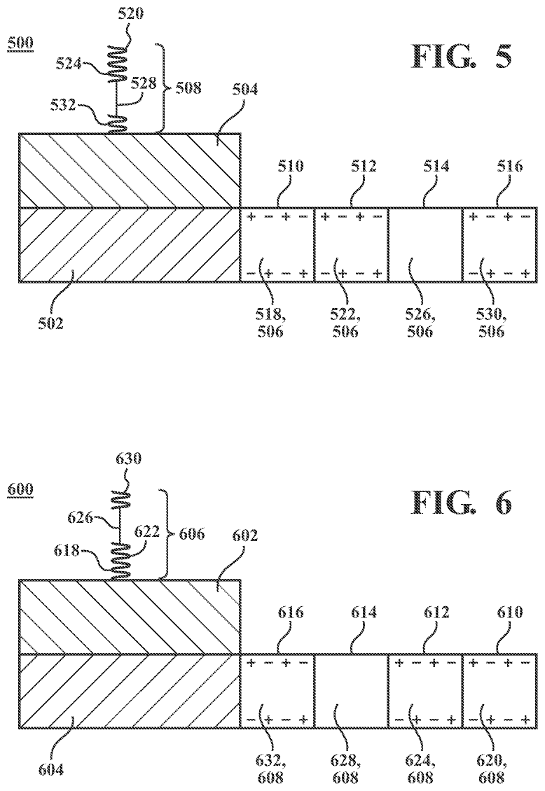

FIG. 4 includes a table 400 that illustrates sources of power for the first device and the second device as a function of the rate at which the energy storage device bank stores energy received from the magnetoelectric energy harvester, according to the disclosed technologies. For example, the table 400 can include columns for a first rate 402, a second rate 404, a third rate 406, and a fourth rate 408. For example, the first rate 402 can be less than two units of energy per unit of time, the second rate 404 can be between two and three units of energy per unit of time, the third rate 406 can be between three and five units of energy per unit of time, and the fourth rate 408 can be greater than five units of energy per unit of time.

Returning to FIG. 3, additionally, for example, the controller module 308 can further include instructions that function to control the processor 302 to cause, in response to the rate at which the energy storage device bank stores energy received from the magnetoelectric energy harvester being greater than the sum of the power consumption rate of the first device and the power consumption rate of the second device, the energy source to receive the power from the energy storage device bank. With reference to FIG. 2, for example, if the rate at which the energy storage device bank 200 stores energy from the magnetoelectric energy harvester 100 is greater than five units of energy per unit of time, then each of the eighth switch 202c, the ninth switch 204c, the tenth switch 206c, the eleventh switch 208c, the twelfth switch 210c, the thirteenth switch 212c, and the eighteenth switch 238 can be closed in a manner so that the energy source 228 can be configured to receive power from the energy storage device bank 200.

Returning to FIG. 3, additionally, for example, the controller module 308 can further include instructions that function to control the processor 302 to cause a first energy storage device, of the energy storage device bank, to be configured to store the energy received from the magnetoelectric energy harvester. For example, the rate analysis module 306 can further include instructions that function to control the processor 302 to determine that an amount of energy stored by the first energy storage device is at a capacity of the first energy storage device. For example, the controller module 308 can further include instructions that function to control the processor 302 to cause, in response to a determination that the amount of energy stored by the first energy storage device is at the capacity of the first energy storage device: (1) a second energy storage device, of the energy storage device bank, to be configured to store the energy received from the magnetoelectric energy harvester and (2) the first energy storage device to be configured to cease storing the energy received from the magnetoelectric energy harvester.

With reference to FIG. 2, for example, each of the first switch 202a and the seventh switch 218 can be closed in a manner so that the first energy storage device 202 can be configured to store the energy received from the magnetoelectric energy harvester 100. For example, the first sensor 202b can sense that the amount of energy stored by the first energy storage device 202 is at the capacity of the first energy storage device 202. For example, in response to the determination that the amount of energy stored by the first energy storage device 202 is at the capacity of the first energy storage device 202: (1) the second switch 204a can be closed in a manner so that the second energy storage device 204 can be configured to store the energy received from the magnetoelectric energy harvester 100 and (2) the first switch 202a can be opened in a manner so that the first energy storage device 202 can be configured to cease storing the energy received from the magnetoelectric energy harvester 100.

In an implementation, the first device 224 can include one of a sensing device and a communications device, the second device 226 can include one of the sensing device and the communications device, but the second device 226 can be different from the first device 224. That is, in this implementation, one of the first device 224 or the second device 226 can include the sensing device and the other of the first device 224 or the second device 226 can include the communications device. In a variation of this implementation, the sensing device can be communicably connected to the communications device. For example, the first device 224 can be connected to the second device 226 by a fifth conductor 240. For example, the sensing device can include one or more of a humidity sensing device, a vibration sensing device, a temperature sensing device, a water leak sensing device, an uninterrupted power supply monitoring sensing device, a current sensing device, a power alignment sensing device, a proximity sensing device, an imaging device (e.g., a camera), a ranging device, or the like. For example, the communications device can include one or more of a transmitter, a receiver, a transceiver, or the like. For example, the transmitter can include a magnetoelectric energy transmitter. For example, the receiver can include a magnetoelectric energy receiver.

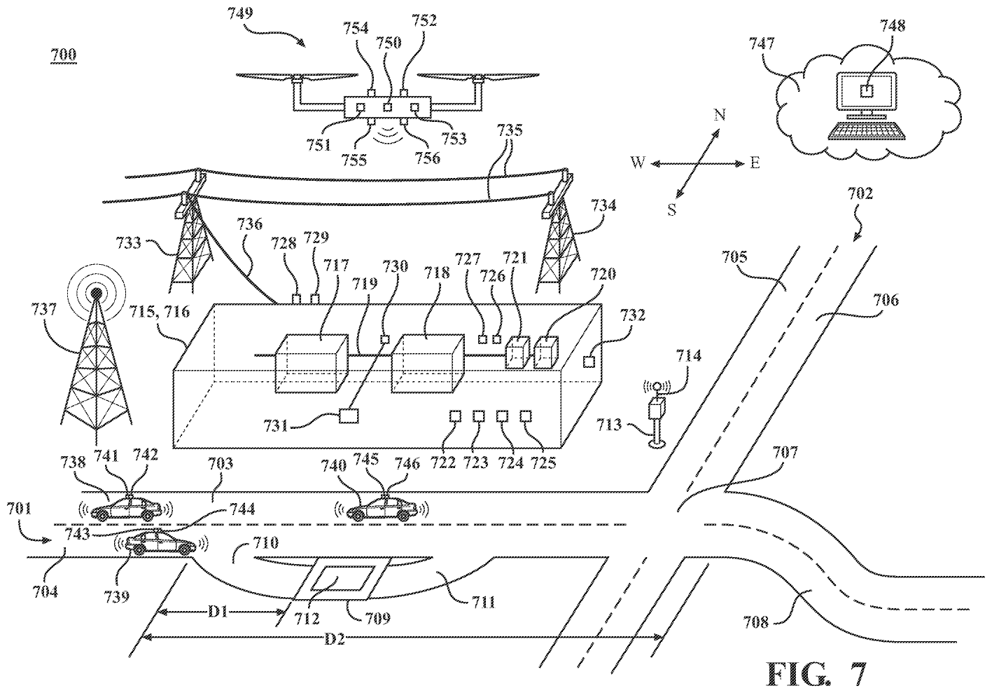

FIG. 5 includes a diagram that illustrates an example of a magnetoelectric energy transmitter 500, according to the disclosed technologies. The magnetoelectric energy transmitter 500 can include, for example, a piezoelectric layer 502 and a magnetostriction layer 504. The piezoelectric layer 502 can be coupled to the magnetostriction layer 504. The piezoelectric layer 502 can be configured so that, in response to varying electrostatic potentials 506 being applied across the piezoelectric layer 502, the piezoelectric layer 502 can change shape. Because the magnetostriction layer 504 is coupled to the piezoelectric layer 502, a change in shape of the piezoelectric layer 502 can cause a change in shape of the magnetostriction layer 504. The magnetostriction layer 504 can be configured so that, in response to a change in shape of the magnetostriction layer 504, the magnetostriction layer 504 can produce electromagnetic waves 508 that can radiate from the magnetoelectric energy transmitter 500. That is, the magnetoelectric energy transmitter 500 can be a device identical to the magnetoelectric energy harvester 100 (illustrated in FIG. 1), but operating in a mode of a transmitter. For example, an environment of the magnetoelectric energy transmitter 500 can include a first set of memory cells 510, a second set of memory cells 512, a third set of memory cells 514, and a fourth set of memory cells 516. For example, the first set of memory cells 510 can store a set of varying electrostatic potentials 518 that can be transmitted by the magnetoelectric energy transmitter 500 as electromagnetic waves 520 that represent a one. For example, the second set of memory cells 512 can store a set of varying electrostatic potentials 522 that can be transmitted by the magnetoelectric energy transmitter 500 as electromagnetic waves 524 that represent a one. For example, the third set of memory cells 514 can store a set of electrostatic potentials 526 that can be transmitted by the magnetoelectric energy transmitter 500 as electromagnetic waves 528 that represent a zero. For example, the fourth set of memory cells 516 can store a set of varying electrostatic potentials 530 that can be transmitted by the magnetoelectric energy transmitter 500 as electromagnetic waves 532 that represent a one.

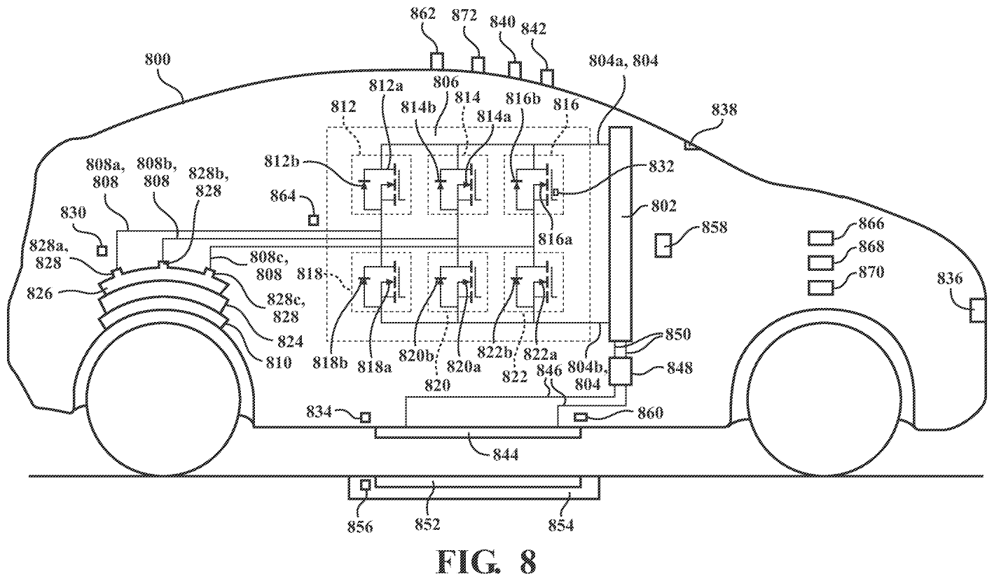

FIG. 6 includes a diagram that illustrates an example of a magnetoelectric energy receiver 600, according to the disclosed technologies. The magnetoelectric energy receiver 600 can include, for example, a magnetostriction layer 602 and a piezoelectric layer 604. The magnetostriction layer 602 can be coupled to the piezoelectric layer 604. The magnetostriction layer 602 can be configured so that, in response to being in a presence of varying electromagnetic waves 606, the magnetostriction layer 602 can change shape. Because the piezoelectric layer 604 is coupled to the magnetostriction layer 602, a change in shape of the magnetostriction layer 602 can cause a change in shape of the piezoelectric layer 604. The piezoelectric layer 604 can be configured so that, in response to a change in shape of the piezoelectric layer 604, the piezoelectric layer 604 can produce varying electrostatic potentials 608 across the piezoelectric layer 604. That is, the magnetoelectric energy receiver 600 can be a device identical to the magnetoelectric energy harvester 100 (illustrated in FIG. 1), but, for the magnetoelectric energy harvester 100, the varying magnetic field 106 (illustrated in FIG. 1) can be treated as electrical energy to be stored as the electric potential 108 (illustrated in FIG. 1), while, for the magnetoelectric energy receiver 600, the varying electromagnetic waves 606 can be treated as a signal represented by the varying electrostatic potentials 608. For example, an environment of the magnetoelectric energy receiver 600 can include a first set of memory cells 610, a second set of memory cells 612, a third set of memory cells 614, and a fourth set of memory cells 616. For example, electromagnetic waves 618 that represent a one can be received by the magnetoelectric energy receiver 600 and stored as a set of varying electrostatic potentials 620 in the first set of memory cells 610. For example, electromagnetic waves 622 that represent a one can be received by the magnetoelectric energy receiver 600 and stored as a set of varying electrostatic potentials 624 in the second set of memory cells 612. For example, electromagnetic waves 626 that represent a zero can be received by the magnetoelectric energy receiver 600 and stored as a set of electrostatic potentials 628 in the third set of memory cells 614. For example, electromagnetic waves 630 that represent a one can be received by the magnetoelectric energy receiver 600 and stored as a set of varying electrostatic potentials 632 in the fourth set of memory cells 616.

Returning to FIG. 3, although, in general, the condition can be any condition, in another variation of this implementation (i.e., one of the first device 224 or the second device 226 including the sensing device and the other of the first device 224 or the second device 226 including the communications device), the condition can be specific. For example, in this other variation of this implementation, the memory 304 can further store a condition determination module 310.

For example, if the first device includes the communications device, then the condition determination module 310 can include instructions that function to control the processor 302 to determine that the condition can include the communications device needing to be in a state to perform a communication. With reference to FIG. 2, for example, if: (1) the first device 224 includes the communications device, (2) the power consumption rate of the first device 224 is three units of energy per unit of time, (3) the rate at which the energy storage device bank 200 stores energy from the magnetoelectric energy harvester 100 is greater than three units of energy per unit of time, but (4) the communications device does not need to be in the state to perform the communication, then although the rate at which the energy storage device bank 200 stores energy from the magnetoelectric energy harvester 100 is greater than three units of energy per unit of time, each of the eighth switch 202c, the ninth switch 204c, the tenth switch 206c, the eleventh switch 208c, the twelfth switch 210c, the thirteenth switch 212c, and the fourteenth switch 220 may not be closed in a manner so that the first device 224 can be configured to receive power from the energy storage device bank 200.

Returning to FIG. 3, for example, if the second device includes the communications device, then the condition determination module 310 can include instructions that function to control the processor 302 to determine that the condition can include the communications device needing to be in a state to perform a communication. With reference to FIG. 2, for example, if: (1) the second device 226 includes the communications device, (2) the power consumption rate of the second device 226 is two units of energy per unit of time, (3) the rate at which the energy storage device bank 200 stores energy from the magnetoelectric energy harvester 100 is greater than two units of energy per unit of time, but (4) the communication device does not need to be in the state to perform the communication, then each of the eighth switch 202c, the ninth switch 204c, the tenth switch 206c, the eleventh switch 208c, the twelfth switch 210c, the thirteenth switch 212c, and the fifteenth switch 222 may not be closed in a manner so that the second device 226 can be configured to receive power from the energy storage device bank 200.

Returning to FIG. 3, for example, if the first device includes the sensing device, then the condition determination module 310 can include instructions that function to control the processor 302 to determine that the condition can include the sensing device needing to be in a state to perform a sensing operation. With reference to FIG. 2, for example, if: (1) the first device 224 includes the sensing device, (2) the power consumption rate of the first device 224 is three units of energy per unit of time, (3) the rate at which the energy storage device bank 200 stores energy from the magnetoelectric energy harvester 100 is greater than three units of energy per unit of time, but (4) the sensing device does not need to be in the state to perform the sensing operation, then although the rate at which the energy storage device bank 200 stores energy from the magnetoelectric energy harvester 100 is greater than three units of energy per unit of time, each of the eighth switch 202c, the ninth switch 204c, the tenth switch 206c, the eleventh switch 208c, the twelfth switch 210c, the thirteenth switch 212c, and the fourteenth switch 220 may not be closed in a manner so that the first device 224 can be configured to receive power from the energy storage device bank 200.

Returning to FIG. 3, for example, if the second device includes the sensing device, then the condition determination module 310 can include instructions that function to control the processor 302 to determine that the condition can include the sensing device needing to be in a state to perform a sensing operation. With reference to FIG. 2, for example, if: (1) the second device 226 includes the sensing device, (2) the power consumption rate of the second device 226 is two units of energy per unit of time, (3) the rate at which the energy storage device bank 200 stores energy from the magnetoelectric energy harvester 100 is greater than two units of energy per unit of time, but (4) the sensing device does not need to be in the state to perform the sensing operation, then each of the eighth switch 202c, the ninth switch 204c, the tenth switch 206c, the eleventh switch 208c, the twelfth switch 210c, the thirteenth switch 212c, and the fifteenth switch 222 may not be closed in a manner so that the second device 226 can be configured to receive power from the energy storage device bank 200.

In another implementation, the memory 304 can further store the condition determination module 310. The condition determination module 310 can include instructions that function to control the processor 302 to determine, by operating a neural network, the existence of the condition.

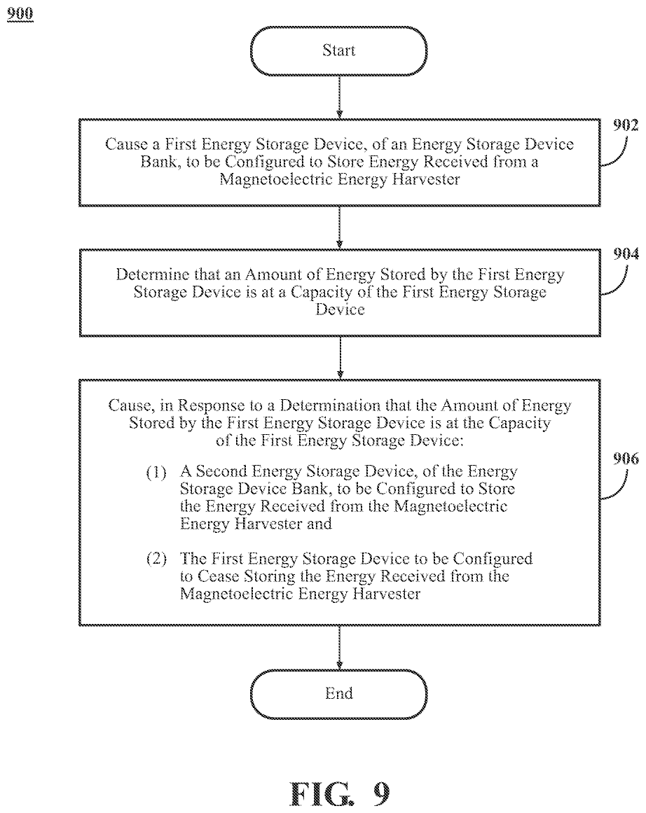

FIG. 7 includes a diagram that illustrates an example of an environment 700 for providing power to devices from a magnetoelectric energy harvester, according to the disclosed technologies. The environment 700 can include, for example, a first road 701 (disposed along a line of latitude) and a second road 702 (disposed along a line of longitude). The first road 701 can include, for example, a lane 703 for westbound traffic and a lane 704 for eastbound traffic. The second road 702 can include, for example, a lane 705 for southbound traffic and a lane 706 for northbound traffic. An intersection 707 can be formed by the first road 701 and the second road 702. For example, the first road 701 west of the intersection 707 and the second road 702 can be situated on flat land, but the first road 701 east of the intersection 707 can be situated on a downward slope of a hill 708. For example, a charging station 709 can be situated south of the first road 701. An offramp 710 can connect the lane 704 to the charging station 709 and an onramp 711 can connect the charging station 709 to the lane 704. For example, the charging station 709 can include a wireless power transmitting coil 712. For example, a roadside unit 713 can be situated at a northwest corner of the intersection 707. For example, the roadside unit 713 can include a communications device 714.

For example, a building 715 can be situated north of the first road 701. For example, the building 715 can include a data center 716. For example, the data center 716 can include a first server rack 717 and a second server rack 718. A power cable 719 can be configured to provide power to the first server rack 717 and the second server rack 718. For example, an energy source 720 can be configured to provide power to the power cable 719. For example, the energy source 720 can include one or more of a battery, a fuel cell, a capacitor, a supercapacitor, or the like. The energy source 720 can be connected to the power cable 719 via an inverter 721. For example, one or more of a temperature sensing device 722, a vibration sensing device 723, a humidity sensing device 724, a water leak sensing device 725, an uninterrupted power supply monitoring sensing device 726, a current sensing device 727, or the like can be disposed within the data center 716. For example, one or more of a transmitter 728 or a receiver 729 can be disposed within the data center 716. For example, the one or more of the transmitter 728 or the receiver 729 can be communicably connected to the one or more of the temperature sensing device 722, the vibration sensing device 723, the humidity sensing device 724, the water leak sensing device 725, the uninterrupted power supply monitoring sensing device 726, or the current sensing device 727. For example, a magnetoelectric energy harvester 730 and an energy storage device bank 731 can be disposed within the data center 716. For example, the magnetoelectric energy harvester 730 can be disposed in a vicinity of the power cable 719 and can be electrically connected to the energy storage device bank 731. For example, the energy storage device bank 731 can be configured to provide power to the one or more of the temperature sensing device 722, the vibration sensing device 723, the humidity sensing device 724, the water leak sensing device 725, the uninterrupted power supply monitoring sensing device 726, the current sensing device 727, the transmitter 728, or the receiver 729. For example, the data center 716 can include a diagnostics system 732.

For example, the environment 700 can include a first power transmission tower 733 and a second power transmission tower 734 to support power transmission lines 735. For example, a service drop line 736 can connect one of the power transmission lines 735 to the power cable 719. For example, the environment 700 can include a radio tower 737. For example, the environment 700 can include a first vehicle 738, a second vehicle 739, a third vehicle 740. For example, the first vehicle 738 can be located in the lane 703 and can be moving west. For example, the second vehicle 739 can be located in the lane 704 and can be moving cast. For example, the third vehicle 740 can be located in the lane 703 behind the first vehicle 738 and can be moving west. For example, the first vehicle 738 can include a transmitter 741 and a receiver 742, the second vehicle 739 can include a transmitter 743 and a receiver 744, and the third vehicle 740 can include a transmitter 745 and a receiver 746. For example, the environment 700 can include a cloud computing platform 747. For example, can include a communications device 748. For example, the environment 700 can include an aerial vehicle 749. For example, the aerial vehicle 749 can be an unmanned aerial vehicle. For example, the aerial vehicle 749 can include an energy source 750, an inverter 751, a magnetoelectric energy harvester 752, an energy storage device bank 753, a sensor 754, a transmitter 755, and a receiver 756. For example, the one or more of the transmitter 755 or the receiver 756 can be communicably connected to the sensor 754. For example, the energy source 750 can include one or more of a battery, a fuel cell, a capacitor, a supercapacitor, or the like. For example, the energy source 750 can be configured to provide power to the aerial vehicle 749 via the inverter 751. For example, the magnetoelectric energy harvester 752 can be electrically connected to the energy storage device bank 753. For example, the energy storage device bank 753 can be configured to provide power to one or more of the sensor 754, the transmitter 755, or the receiver 756.

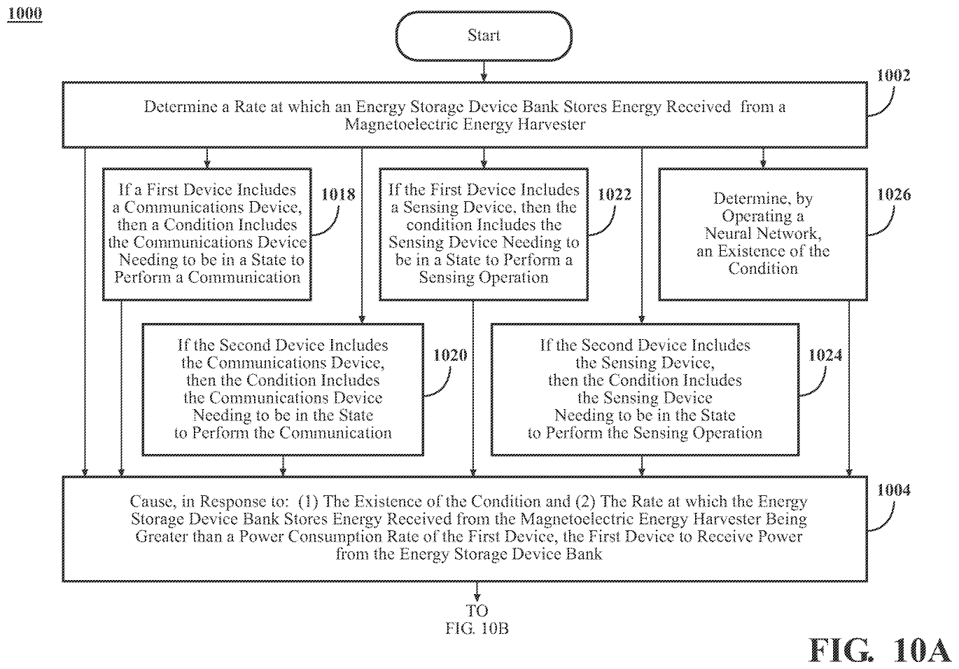

FIG. 8 includes a diagram that illustrates an example of a vehicle 800 configured to provide power to devices from a magnetoelectric energy harvester, according to the disclosed technologies. The vehicle 800 can include, for example, an energy source 802, a first set of power cables 804, an inverter 806, a second set of power cables 808, and an electric motor 810. The energy source 802 can be configured to produce power in a direct current form. For example, the energy source 802 can include a battery, a fuel cell, a capacitor, a supercapacitor, or the like. The first set of power cables 804 can be configured to convey the power in the direct current form from the energy source 802 to the inverter 806. The inverter 806 can be configured to convert the power in the direct current form to power in an alternating current form. The second set of power cables 808 can be configured to convey the power in the alternating current form from the inverter 806 to the electric motor 810. The electric motor 810 can be configured to receive the power in the alternating current form and to produce a propulsion force for the vehicle 800.

For example, the inverter 806 can include a first set of circuitry 812, a second set of circuitry 814, a third set of circuitry 816, a fourth set of circuitry 818, a fifth set of circuitry 820, and a sixth set of circuitry 822. For example, the first set of circuitry 812 can include a first power field-effect transistor 812a connected in parallel with a first diode 812b, the second set of circuitry 814 can include a second power field-effect transistor 814a connected in parallel with a second diode 814b, the third set of circuitry 816 can include a third power field-effect transistor 816a connected in parallel with a third diode 816b, the fourth set of circuitry 818 can include a fourth power field-effect transistor 818a connected in parallel with a fourth diode 818b, the fifth set of circuitry 820 can include a fifth power field-effect transistor 820a connected in parallel with a fifth diode 820b, and the sixth set of circuitry 822 can include a sixth power field-effect transistor 822a connected in parallel with a sixth diode 822b. For example, one or more of the first power field-effect transistor 812a, the second power field-effect transistor 814a, the third power field-effect transistor 816a, the fourth power field-effect transistor 818a, the fifth power field-effect transistor 820a, or the sixth power field-effect transistor 822a can be a silicon carbide field-effect transistor. For example, a first power cable 804a, of the first set of power cables 804, can be connected to the first set of circuitry 812, the second set of circuitry 814, and the third set of circuitry 816. For example, a second power cable 804b, of the first set of power cables 804, can be connected to the fourth set of circuitry 818, the fifth set of circuitry 820, and the sixth set of circuitry 822. For example, a first power cable 808a, of the second set of power cables 808, can be connected to the first set of circuitry 812 and the fourth set of circuitry 818. For example, a second power cable 808b, of the second set of power cables 808, can be connected to the second set of circuitry 814 and the fifth set of circuitry 820. For example, a third power cable 808c, of the second set of power cables 808, can be connected to the third set of circuitry 816 and the sixth set of circuitry 822.

For example, a power control unit 824 can be associated with the electric motor 810. For example, the power control unit 824 can include a power card package 826. For example, the power card package 826 can have a set of electrodes 828. For example, a first electrode 828a, of the set of electrodes 828, can be connected to the first power cable 804a. For example, a second electrode 828b, of the set of electrodes 828, can be connected to the second power cable 804b. For example, a third electrode 828c, of the set of electrodes 828, can be connected to the third power cable 804c.

For example, one or more of a first current sensing device 830, a second current sensing device 832, a first power alignment sensing device 834, a proximity sensing device 836, an imaging device 838 (e.g., a camera), a ranging device 872, or the like can be disposed on the vehicle 800. For example, one or more of a transmitter 840 or a receiver 842 can be disposed on the vehicle 800. For example, the one or more of the transmitter 840 or the receiver 842 can be communicably connected to the one or more of the first current sensing device 830, the second current sensing device 832, the first power alignment sensing device 834, the proximity sensing device 836, the imaging device 838 (e.g., the camera), or the ranging device 872. For example, the first current sensing device 830 can be configured to produce a measure of an amount of current that flows through an electrode of the set of electrodes 828 (e.g., the first electrode 828a, the second electrode 828b, or the third electrode 828c) of the power card package 826 of the power control unit 824 associated with the electric motor 810. For example, the second current sensing device 832 can be configured to produce a measure of an amount of gate-leakage current from a gate electrode of a power field-effect transistor (e.g., the first power field-effect transistor 812a, the second power field-effect transistor 814a, the third power field-effect transistor 816a, the fourth power field-effect transistor 818a, the fifth power field-effect transistor 820a, or the sixth power field-effect transistor 822a).

For example, the vehicle 800 can include a wireless power receiving coil 844, a third set of power cables 846, a power converter 848 (e.g., a rectifier), and a fourth set of power cables 850. The wireless power receiving coil 844 can be configured to produce, in a presence of a magnetic field, power in an alternating current form. The third set of power cables 846 can be configured to convey the power in the alternating current form from the wireless power receiving coil 844 to the power converter 848. The power converter 848 can be configured to convert the power in the alternating current form to power in a direct current form. The fourth set of power cables 850 can be configured to convey the power in the direct current form from the power converter 848 to the energy source 802. For example, the magnetic field, from which the wireless power receiving coil 844 can produce the power in the alternating current form, can be produced by a wireless power transmitting coil 852 included in a charging station 854 in an environment of the vehicle 800. For example, the first power alignment sensing device 834 can be configured to sense a degree of alignment between the wireless power receiving coil 844 and the wireless power transmitting coil 852. For example, the charging station can include a second power alignment sensing device 856 configured to sense the degree of alignment between the wireless power receiving coil 844 and the wireless power transmitting coil 852.

For example, the vehicle 800 can include an energy storage device bank 858, a first magnetoelectric energy harvester 860, a second magnetoelectric energy harvester 862, and a third magnetoelectric energy harvester 864. For example, the first magnetoelectric energy harvester 860 can be: (1) disposed on the vehicle 800 in a vicinity of the wireless power receiving coil 844 and (2) electrically connected to the energy storage device bank 858. For example, the second magnetoelectric energy harvester 862 can be: (1) disposed on the vehicle 800 at a position to be exposed to radio frequency waves associated with communications among one or more of vehicles or between one vehicle and another communications device and (2) electrically connected to the energy storage device bank 858. For example, the third magnetoelectric energy harvester 864 can be: (1) disposed on the vehicle 800 in a vicinity of one or more power cables of the second set of power cables 808 (e.g., the first power cable 808a, the second power cable 808b, or the third power cable 808c) and (2) electrically connected to the energy storage device bank 858. For example, the energy storage device bank 858 can be configured to provide power to the one or more of the first current sensing device 830, the second current sensing device 832, the first power alignment sensing device 834, the proximity sensing device 836, the imaging device 838 (e.g., the camera), the ranging device 872, the transmitter 840, or the receiver 842.

For example, the vehicle 800 can include a diagnostics system 866, a processor 868, and a memory 870.

Returning to FIGS. 2 and 3, in a realization of the disclosed technologies, for example, one or more of the processor 302, the memory 304, the energy storage device bank 200, the magnetoelectric energy harvester 100, the first device 224, or the second device 226 can be disposed on a vehicle. With reference to FIG. 8, for example: (1) the vehicle can be the vehicle 800, (2) the processor 302 can be the processor 868. (3) the memory 304 can be the memory 870, (4) the energy storage device bank 200 can be the energy storage device bank 858, (5) the magnetoelectric energy harvester 100 can be one or more of the first magnetoelectric energy harvester 860, the second magnetoelectric energy harvester 862, or the third magnetoelectric energy harvester 864, and (6) one or more of the first device 224 or the second device 226 can be one or more of the first current sensing device 830, the second current sensing device 832, the first power alignment sensing device 834, the proximity sensing device 836, the imaging device 838 (e.g., the camera), the ranging device 872, the transmitter 840, or the receiver 842.

In a variation of this realization: (1) the vehicle can include a wireless power receiving coil configured to produce, in a presence of a magnetic field, power in an alternating current form and (2) the magnetoelectric energy harvester can be disposed on the vehicle in a vicinity of the wireless power receiving coil. For example, the wireless power receiving coil can be the wireless power receiving coil 844 and the magnetoelectric energy harvester can be the first magnetoelectric energy harvester 860. Additionally, for example, one or more of the first device or the second device can include a power alignment sensing device configured to sense a degree of alignment between the wireless power receiving coil and a wireless power transmitting coil. For example, the power alignment sensing device can be the first power alignment sensing device 834.

In another variation of this realization, the magnetoelectric energy harvester can be disposed on the vehicle at a position to be exposed to radio frequency waves associated with communications among one or more of vehicles or between one vehicle and another communications device. For example, the magnetoelectric energy harvester can be the second magnetoelectric energy harvester 862. With reference to FIG. 7, for example, the vehicle can be the second vehicle 739, the communications among the vehicles can be the communications between the first vehicle 738 and the third vehicle 740, and the communications among the one vehicle and the other communications device can be the communications between the first vehicle 738 and the communications device 714 included in the roadside unit 713.

In yet another variation of this realization, for example, the vehicle can include an energy source, an inverter, power cables, and an electric motor. The energy source can be configured to produce power in a direct current form. The inverter can be configured to convert the power in the direct current form to power in an alternating current form. The power cables can be configured to convey the power in the alternating current form from the inverter to the electric motor. The electric motor can be configured to receive the power in the alternating current form and to produce a propulsion force for the vehicle. The magnetoelectric energy harvester can be disposed on the vehicle in a vicinity of the power cables. With reference to FIG. 8, for example, the energy source can be the energy source 802, the inverter can be the inverter 806, the power cables can be the second set of power cables 808, the electric motor can be the electric motor 810, and the magnetoelectric energy harvester can be the third magnetoelectric energy harvester 864.

Returning to FIG. 3, in an implementation of yet this other variation of this realization, for example, the rate analysis module 306 can further include instructions that function to control the processor 302 to determine, over a duration of time, a change in the rate at which the energy storage device bank stores energy received from the magnetoelectric energy harvester. The duration of time can be longer than a duration of a cycle of the power in the alternating current form. That is, the duration of time over which the change in the rate at which the energy storage device bank stores energy received from the magnetoelectric energy harvester occurs (i.e., measured in months) can be longer than the cycle of the power in the alternating current form (i.e., measured in fractions of a second).

For example, in this implementation of yet this other variation of this realization, the memory 304 can further store a motor analysis module 312. The motor analysis module 312 can include instructions that function to control the processor 302 to determine, based on the change in the rate over the duration of time, a change in an amount of current that flows through the power cables. Such a change in the amount of current that flows through the power cables over the duration of time can be indicative of a degree of deterioration of the electric motor.

For example, in this implementation of yet this other variation of this realization, one or more of: (1) the motor analysis module 312 can further include instructions to determine, based on the change in the amount of current, the degree of deterioration of the electric motor or (2) the memory 304 can further store a communications module 314. The communications module 314 can include instructions that function to control the processor 302 to cause a message to be transmitted. The message can include information about the change in the amount of current. With reference to FIG. 8, for example, the transmitter 840 can transmit the message to the diagnostics system 866. With reference to FIG. 7, additionally or alternatively, for example, the transmitter 743, included on the second vehicle 739, can transmit the message to the communications device 748 included in the cloud computing platform 747.

Returning to FIGS. 2, 3, and 8, in another implementation of yet this other variation of this realization, for example, one or more of the first device 224 or the second device 226 can include a current sensing device. For example, the current sensing device can be the first current sensing device 830.

For example, in this other implementation of yet this other variation of this realization, the memory 304 can further store the motor analysis module 312. The motor analysis module 312 can include instructions that function to control the processor 302 to receive, from the current sensing device (e.g., the first current sensing device 830), a measure of an amount of current that flows through an electrode of a power card package of a power control unit associated with the electric motor. For example, the electrode can be an electrode of the set of electrodes 828 (e.g., the first electrode 828a, the second electrode 828b, or the third electrode 828c), the power card package can be the power card package 826, the power control unit can be the power control unit 824, and the electric motor can be the electric motor 810. Such a measure of the amount of current that flows through the electrode can be indicative of a degree of deterioration of the electric motor.

For example, in this other implementation of yet this other variation of this realization, one or more of: (1) the motor analysis module 312 can further include instructions to determine, based on the measure of the amount of current, the degree of deterioration of the electric motor or (2) the memory 304 can further store the communications module 314. The communications module 314 can include instructions that function to control the processor 302 to cause a message to be transmitted. The message can include information about the measure of the amount of current. With reference to FIG. 8, for example, the transmitter 840 can transmit the message to the diagnostics system 866. With reference to FIG. 7, additionally or alternatively, for example, the transmitter 743, included on the second vehicle 739, can transmit the message to the communications device 748 included in the cloud computing platform 747.

Returning to FIGS. 2, 3, and 8, in yet another implementation of yet this other variation of this realization, for example, one or more of the first device 224 or the second device 226 can include a current sensing device. For example, the current sensing device can be the second current sensing device 832.

For example, in yet this other implementation of yet this other variation of this realization, the memory 304 can further store the motor analysis module 312. The motor analysis module 312 can include instructions that function to control the processor 302 to receive, from the current sensing device (e.g., the second current sensing device 832), a measure of an amount of gate-leakage current from a gate electrode of a power field-effect transistor. For example, the power field-effect transistor can be one of the first power field-effect transistor 812a, the second power field-effect transistor 814a, the third power field-effect transistor 816a, the fourth power field-effect transistor 818a, the fifth power field-effect transistor 820a, or the sixth power field-effect transistor 822a. Such a measure of the amount of the gate-leakage current from the gate electrode of the power field-effect transistor can be indicative of a degree of deterioration of the power field-effect transistor.

For example, in yet this other implementation of yet this other variation of this realization, one or more of: (1) the motor analysis module 312 can further include instructions to determine, based on the measure of the amount of gate-leakage current, the degree of deterioration of the power field-effect transistor or (2) the memory 304 can further store the communications module 314. The communications module 314 can include instructions that function to control the processor 302 to cause a message to be transmitted. The message can include information about the measure of the amount of gate-leakage current. With reference to FIG. 8, for example, the transmitter 840 can transmit the message to the diagnostics system 866. With reference to FIG. 7, additionally or alternatively, for example, the transmitter 743, included on the second vehicle 739, can transmit the message to the communications device 748 included in the cloud computing platform 747.

Returning to FIGS. 2, 3, 7, and 8, in still another variation of this realization, for example, the vehicle can include an energy source. For example, the energy source can be the energy source 802.

For example, in this still other variation of this realization, the memory 304 can further store a route information module 316. The route information module 316 can include instructions that function to control the processor 302 to obtain information associated with a route being traversed by the vehicle. The information can include information about one or more of an intention or an opportunity to have the vehicle perform, at a specific location along the route, an operation to increase an amount of energy available from the energy source. For example, the route information module 316 of the second vehicle 739 (i.e., the vehicle 800) can obtain information about one or more of: (1) an intention to have the second vehicle 739 (i.e., the vehicle 800) perform, at the charging station 709, an operation to increase the amount of energy available from the energy source 802 or (2) an opportunity to have the second vehicle 739 (i.e., the vehicle 800) perform, while traversing the downward slope of the hill 708, a regenerative braking operation to increase the amount of energy available from the energy source 802.

For example, although, in general, the condition can be any condition, in this still other variation of this realization (i.e., obtaining information about the one or more of the intention or the opportunity to have the vehicle 800 perform, at the specific location along the route, the operation to increase the amount of energy available from the energy source 802), the condition can be specific. For example, in this still other variation of this realization, the memory 304 can further store the condition determination module 310. The condition determination module 310 can include instructions that function to control the processor 302 to determine that the condition can include a result, of a determination of the amount of energy available from the energy source 802 when the vehicle 800 is at the specific location, but before a performance of the operation to increase the amount of energy, being less than a threshold.

For example, the condition determination module 310 can determine whether the amount of energy available from the energy source 802 when the vehicle 800 is at the specific location, but before a performance of the operation to increase the amount of energy, is greater than the threshold, equal to the threshold, or less than the threshold. The existence of the condition can be that the result of the determination is that the amount of energy available from the energy source 802 is less than the threshold; a lack of the existence of the condition can be that the result of the determination is that the amount of energy available from the energy source 802 is equal to the threshold or greater than the threshold. For example, if the condition determination module 310 of the second vehicle 739 (i.e., the vehicle 800) determines that a current amount of energy available from the energy source 802 at a current location of the second vehicle 739 (i.e., the vehicle 800) is sufficient to provide power to the second vehicle 739 (i.e., the vehicle 800), the first device 224 (e.g., the one or more of the first current sensing device 830, the second current sensing device 832, the first power alignment sensing device 834, the proximity sensing device 836, the imaging device 838 (e.g., the camera), the ranging device 872, the transmitter 840, or the receiver 842), and the second device 226 (e.g., the one or more of the first current sensing device 830, the second current sensing device 832, the first power alignment sensing device 834, the proximity sensing device 836, the imaging device 838 (e.g., the camera), the ranging device 872, the transmitter 840, or the receiver 842) while the second vehicle 739 (i.e., the vehicle 800) traverses: (1) a distance D₁ from the current location to the charging station 709 or (2) a distance D₂ from the current location to a starting point of the downward slope of the hill 708 so that, when the second vehicle 739 (i.e., the vehicle 800) is at: (1) the charging station 709 or (2) the starting point of the downward slope of the hill 708, the amount of energy available from the energy source 802 is equal to the threshold or greater than the threshold, then there can be the lack of the existence of the condition.

For example, in this still other variation of this realization, the controller module 308 can further include instructions that function to control the processor 302 to cause, in response to the result, of the determination of the amount of energy available from the energy source 802 when the vehicle 800 is at the specific location, but before the performance of the operation to increase the amount of energy, being equal to the threshold or greater than the threshold: (1) the first device 224 (e.g., the one or more of the first current sensing device 830, the second current sensing device 832, the first power alignment sensing device 834, the proximity sensing device 836, the imaging device 838 (e.g., the camera), the ranging device 872, the transmitter 840, or the receiver 842) to receive power from the energy source 802 and (2) the second device 226 (e.g., the one or more of the first current sensing device 830, the second current sensing device 832, the first power alignment sensing device 834, the proximity sensing device 836, the imaging device 838 (e.g., the camera), the ranging device 872, the transmitter 840, or the receiver 842) to receive the power from the energy source 802.

In this manner, because there can be an expectation that the second vehicle 739 (i.e., the vehicle 800) will perform the operation to increase the amount of energy available from the energy source 802 when the second vehicle 739 (i.e., the vehicle 800) is at: (1) the charging station 709 or (2) the starting point of the downward slope of the hill 708, use of the energy storage device bank 858 to provide power to the one or more of: (1) the first device 224 (e.g., the one or more of the first current sensing device 830, the second current sensing device 832, the first power alignment sensing device 834, the proximity sensing device 836, the imaging device 838 (e.g., the camera), the ranging device 872, the transmitter 840, or the receiver 842) to receive power from the energy source 802 or (2) the second device 226 (e.g., the one or more of the first current sensing device 830, the second current sensing device 832, the first power alignment sensing device 834, the proximity sensing device 836, the imaging device 838 (e.g., the camera), the ranging device 872, the transmitter 840, or the receiver 842) can be minimized so that the amount of energy available from the energy storage device bank 858 can be increased while the second vehicle 739 (i.e., the vehicle 800) traverses: (1) the distance D₁ from the current location to the charging station 709 or (2) the distance D₂ from the current location to the starting point of the downward slope of the hill 708.

In another variation of this realization, the vehicle can include an aerial vehicle. For example, the aerial vehicle can be unmanned aerial vehicle. With reference to FIGS. 2 and 7, for example, the vehicle can be the aerial vehicle 749, the magnetoelectric energy harvester 100 can be the magnetoelectric energy harvester 752, and the energy storage device bank 200 can be the energy storage device bank 753. For example, in a presence of a varying magnetic field (e.g., produced by the nearby transmission of electric power in an alternating current form through the power transmission lines 735, a wireless communication of a radio frequency signal from the radio tower 737, or the like), the magnetoelectric energy harvester 752 can produce an electric potential that can be stored as electrical energy in the energy storage device bank 753.

Returning to FIGS. 2 and 3, in another realization of the disclosed technologies, for example, one or more of the processor 302, the memory 304, the energy storage device bank 200, the magnetoelectric energy harvester 100, the first device 224, or the second device 226 can be disposed on a building. With reference to FIGS. 2 and 7, for example, the building can be the building 715, the magnetoelectric energy harvester 100 can be the magnetoelectric energy harvester 730, and the energy storage device bank 200 can be the energy storage device bank 731. For example, in a presence of a varying magnetic field (e.g., produced by the nearby transmission electric power in an alternating current form through the power cable 719), the magnetoelectric energy harvester 730 can produce an electric potential that can be stored as electrical energy in the energy storage device bank 731.

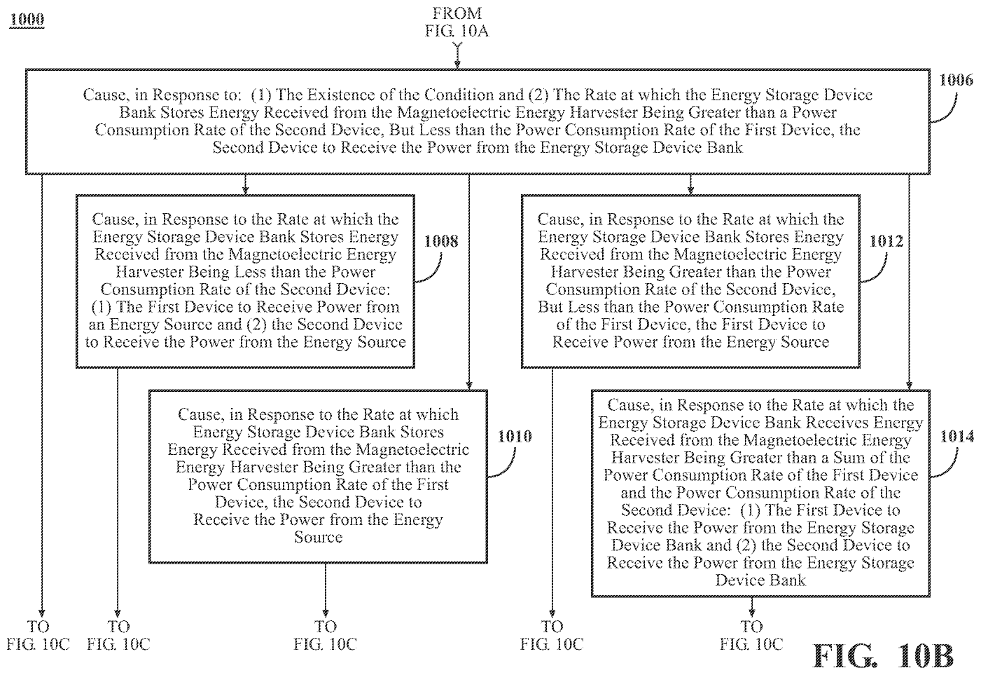

FIG. 9 includes a flow diagram that illustrates an example of a method 900 that is associated with storing energy, received from a magnetoelectric energy harvester, in an energy storage device bank, according to the disclosed technologies. Although the method 900 is described in combination with the magnetoelectric energy harvester 100 illustrated in FIG. 1, the energy storage device bank 200 illustrated in FIG. 2, and the system 300 illustrated in FIG. 3, one of skill in the art understands, in light of the description herein, that the method 900 is not limited to being implemented by the magnetoelectric energy harvester 100 illustrated in FIG. 1, the energy storage device bank 200 illustrated in FIG. 2, and the system 300 illustrated in FIG. 3. Rather, the magnetoelectric energy harvester 100 illustrated in FIG. 1, the energy storage device bank 200 illustrated in FIG. 2, and the system 300 illustrated in FIG. 3 are examples of a magnetoelectric energy harvester, an energy storage device bank, and a system that may be used to implement the method 900. Additionally, although the method 900 is illustrated as a generally serial process, various aspects of the method 900 may be able to be executed in parallel.

In FIG. 9, in the method 900, at an operation 902, for example, the controller module 308 can cause the first energy storage device 202, of the energy storage device bank 200, to be configured to store the energy received from the magnetoelectric energy harvester 100.

At an operation 904, for example, the rate analysis module 306 can determine that an amount of energy stored by the first energy storage device 202 is at a capacity of the first energy storage device 202.

At an operation 906, for example, the controller module 308 can cause, in response to a determination that the amount of energy stored by the first energy storage device 202 is at the capacity of the first energy storage device 202: (1) the second energy storage device 204, of the energy storage device bank 200, to be configured to store the energy received from the magnetoelectric energy harvester 100 and (2) the first energy storage device 202 to be configured to cease storing the energy received from the magnetoelectric energy harvester 100.

For example, one or more of the first energy storage device 202 or the second energy storage device 204 can include one or more of a battery, a capacitor, a supercapacitor, or the like.

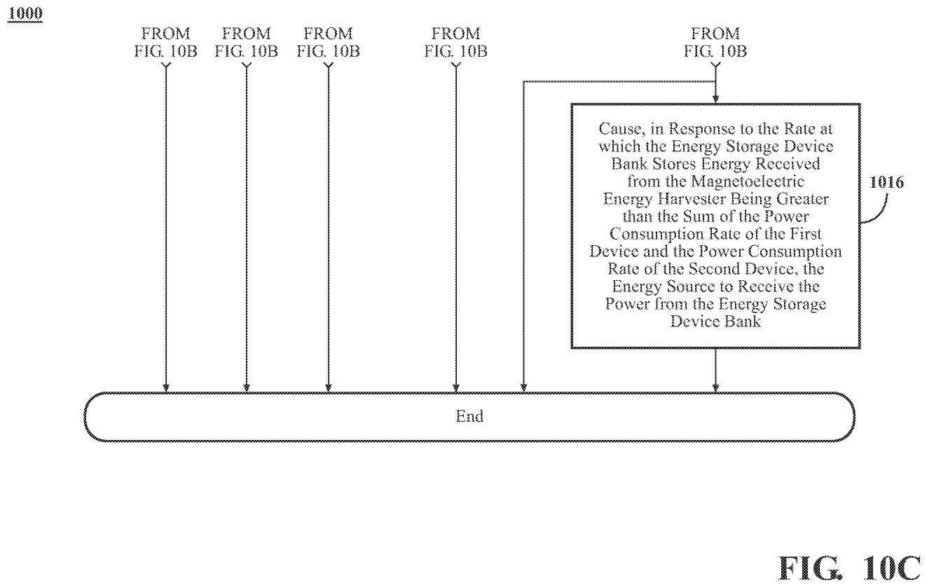

FIGS. 10A through 10C include a flow diagram that illustrates an example of a method 1000 that is associated with providing power to devices from a magnetoelectric energy harvester, according to the disclosed technologies. Although the method 1000 is described in combination with the magnetoelectric energy harvester 100 illustrated in FIG. 1, the energy storage device bank 200 illustrated in FIG. 2, and the system 300 illustrated in FIG. 3, one of skill in the art understands, in light of the description herein, that the method 1000 is not limited to being implemented by the magnetoelectric energy harvester 100 illustrated in FIG. 1, the energy storage device bank 200 illustrated in FIG. 2, and the system 300 illustrated in FIG. 3. Rather, the magnetoelectric energy harvester 100 illustrated in FIG. 1, the energy storage device bank 200 illustrated in FIG. 2, and the system 300 illustrated in FIG. 3 are examples of a magnetoelectric energy harvester, an energy storage device bank, and a system that may be used to implement the method 1000. Additionally, although the method 1000 is illustrated as a generally serial process, various aspects of the method 1000 may be able to be executed in parallel.

In FIG. 10A, in the method 1000, at an operation 1002, for example, the rate analysis module 306 can determine a rate at which the energy storage device bank 200 stores energy received from the magnetoelectric energy harvester 100.

At an operation 1004, for example, the controller module 308 can cause, in response to: (1) an existence of a condition and (2) the rate at which the energy storage device bank 200 stores energy received from the magnetoelectric energy harvester 100 being greater than a power consumption rate of the first device 224, the first device 224 to receive the power from the energy storage device bank 200. In general, the condition can be any condition.

In FIG. 10B, in the method 1000, at an operation 1006, for example, the controller module 308 can cause, in response to: (1) the existence of the condition and (2) the rate at which the energy storage device bank 200 stores energy received from the magnetoelectric energy harvester 100 being greater than a power consumption rate of the second device 226, but less than the power consumption rate of the first device 224, the second device 226 to receive the power from the energy storage device bank 200. In general, the condition can be any condition.

At an operation 1008, for example, the controller module 308 can cause, in response to the rate at which the energy storage device bank 200 stores energy received from the magnetoelectric energy harvester 100 being less than the power consumption rate of the second device 226: (1) the first device 224 to receive power from the energy source 228 and (2) the second device 226 to receive the power from the energy source 228.

For example, the energy source 228 can include one or more of a battery, a fuel cell, a capacitor, a supercapacitor, a transmission line, or the like.

At an operation 1010, for example, the controller module 308 can cause, in response to the rate at which the energy storage device bank 200 stores energy received from the magnetoelectric energy harvester 100 being greater than the power consumption rate of the first device 224, the second device 226 to receive the power from the energy source 228.

At an operation 1012, for example, the controller module 308 can cause, in response to the rate at which the energy storage device bank 200 stores energy received from the magnetoelectric energy harvester 100 being greater than the power consumption rate of the second device 226, but less than the power consumption rate of the first device 224, the first device 224 to receive power from the energy source 228.

At an operation 1014, for example, the controller module 308 can cause, in response to the rate at which the energy storage device bank 200 stores energy received from the magnetoelectric energy harvester 100 being greater than a sum of the power consumption rate of the first device 224 and the power consumption rate of the second device 226: (1) the first device 224 to receive the power from the energy storage device bank 200 and (2) the second device 226 to receive the power from the energy storage device bank 200.

In FIG. 10C, in the method 1000, at an operation 1016, for example, the controller module 308 can cause, in response to the rate at which the energy storage device bank 200 stores energy received from the magnetoelectric energy harvester 100 being greater than the sum of the power consumption rate of the first device 224 and the power consumption rate of the second device 226, the energy source 228 to receive the power from the energy storage device bank 200.

In an implementation, the first device 224 can include one of a sensing device and a communications device, the second device 226 can include one of the sensing device and the communications device, but the second device 226 can be different from the first device 224. In a variation of this implementation, the sensing device can be communicably connected to the communications device. For example, the sensing device can include one or more of a humidity sensing device, a vibration sensing device, a temperature sensing device, a water leak sensing device, an uninterrupted power supply monitoring sensing device, a current sensing device, a power alignment sensing device, a proximity sensing device, an imaging device (e.g., a camera), a ranging device, or the like. For example, the communications device can include one or more of a transmitter, a receiver, a transceiver, or the like. For example, the transmitter can include a magnetoelectric energy transmitter. For example, the receiver can include a magnetoelectric energy receiver.

Although, in general, the condition can be any condition, in another variation of this implementation (i.e., one of the first device 224 or the second device 226 including the sensing device and the other of the first device 224 or the second device 226 including the communications device), the condition can be specific.

In FIG. 10A, in the method 1000, at an operation 1018, for example, if the first device 224 includes the communications device, then the condition determination module 310 can determine that the condition can include the communications device needing to be in a state to perform a communication.

At an operation 1020, for example, if the second device 226 includes the communications device, then the condition determination module 310 can determine that the condition can include the communications device needing to be in a state to perform a communication.

At an operation 1022, for example, if the first device 224 includes the sensing device, then the condition determination module 310 can determine that the condition can include the sensing device needing to be in a state to perform a sensing operation.

At an operation 1024, for example, if the second device 226 includes the sensing device, then the condition determination module 310 can determine that the condition can include the sensing device needing to be in a state to perform a sensing operation.

At an operation 1026, in another implementation, the condition determination module 310 can determine, by operating a neural network, the existence of the condition.

In a realization of the disclosed technologies, for example, at least one of the operations of the method 1000 can be performed on a vehicle. (For example, the vehicle can include an aerial vehicle. For example, the aerial vehicle can be unmanned aerial vehicle.) (In another realization of the disclosed technologies, for example, at least one of the operations of the method 1000 can be performed in a building.)

In a variation of this realization: (1) the vehicle can include a wireless power receiving coil configured to produce, in a presence of a magnetic field, power in an alternating current form and (2) the magnetoelectric energy harvester 100 can be disposed on the vehicle in a vicinity of the wireless power receiving coil. Additionally, for example, one or more of the first device 224 or the second device 226 can include a power alignment sensing device configured to sense a degree of alignment between the wireless power receiving coil and a wireless power transmitting coil.

In another variation of this realization, the magnetoelectric energy harvester 100 can be disposed on the vehicle at a position to be exposed to radio frequency waves associated with communications among one or more of vehicles or between one vehicle and another communications device.

In yet another variation of this realization, for example, the vehicle can include the energy source 228, an inverter, power cables, and an electric motor. The energy source 228 can be configured to produce power in a direct current form. The inverter can be configured to convert the power in the direct current form to power in an alternating current form. The power cables can be configured to convey the power in the alternating current form from the inverter to the electric motor. The electric motor can be configured to receive the power in the alternating current form and to produce a propulsion force for the vehicle. The magnetoelectric energy harvester 100 can be disposed on the vehicle in a vicinity of the power cables.

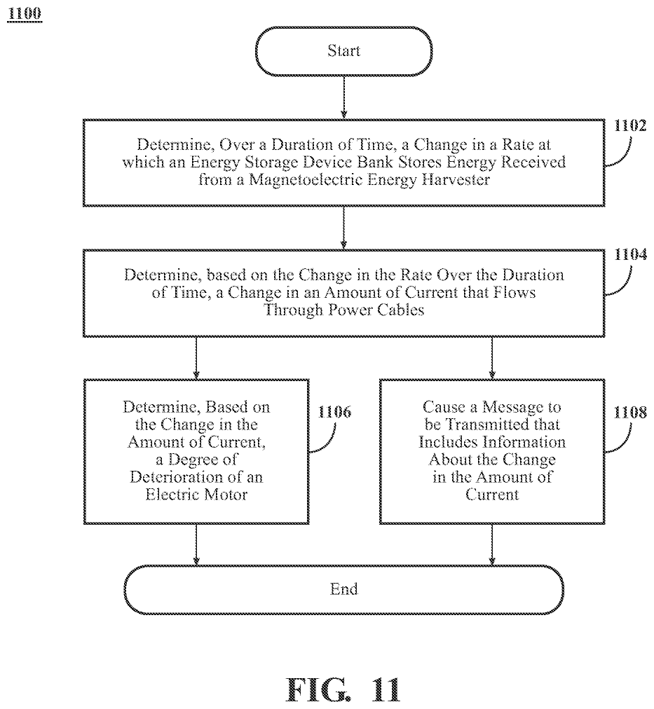

In an implementation of yet this other variation of this realization, for example, a degree of deterioration of the electric motor can be determined according to a first method. FIG. 11 includes a flow diagram that illustrates an example of the first method 1100 that is associated with determining the degree of deterioration of the electric motor, according to the disclosed technologies. Although the method 1100 is described in combination with the magnetoelectric energy harvester 100 illustrated in FIG. 1, the energy storage device bank 200 illustrated in FIG. 2, and the system 300 illustrated in FIG. 3, one of skill in the art understands, in light of the description herein, that the method 1100 is not limited to being implemented by the magnetoelectric energy harvester 100 illustrated in FIG. 1, the energy storage device bank 200 illustrated in FIG. 2, and the system 300 illustrated in FIG. 3. Rather, the magnetoelectric energy harvester 100 illustrated in FIG. 1, the energy storage device bank 200 illustrated in FIG. 2, and the system 300 illustrated in FIG. 3 are examples of a magnetoelectric energy harvester, an energy storage device bank, and a system that may be used to implement the method 1100. Additionally, although the method 1100 is illustrated as a generally serial process, various aspects of the method 1100 may be able to be executed in parallel.

In FIG. 11, in the method 1100, at an operation 1102, for example, the rate analysis module 306 can determine, over a duration of time, a change in the rate at which the energy storage device bank 200 stores energy received from the magnetoelectric energy harvester 100. The duration of time can be longer than a duration of a cycle of the power in the alternating current form.

At an operation 1104, for example, the motor analysis module 312 can determine, based on the change in the rate over the duration of time, a change in an amount of current that flows through the power cables. Such a change in the amount of current that flows through the power cables over the duration of time can be indicative of a degree of deterioration of the electric motor.

At an operation 1106, for example, the motor analysis module 312 can determine, based on the change in the amount of current, the degree of deterioration of the electric motor.

At an operation 1108, for example, the communications module 314 can cause a message to be transmitted. The message can include information about the change in the amount of current.

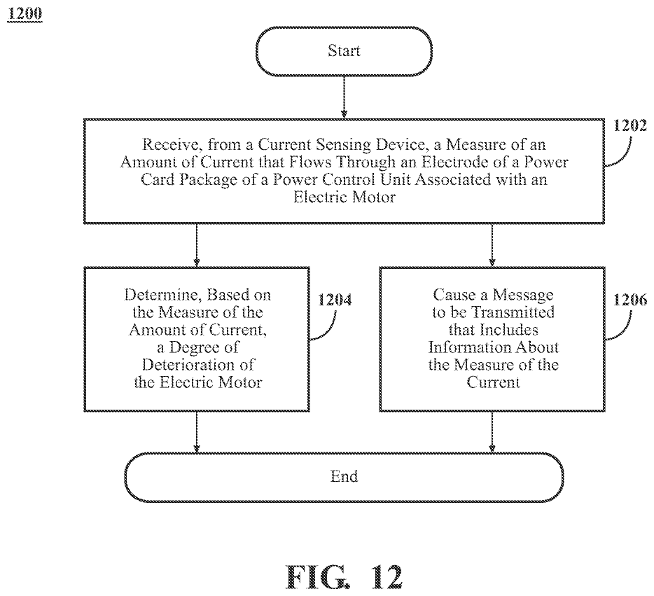

In another implementation of yet this other variation of this realization, for example, the degree of deterioration of the electric motor can be determined according to a second method. FIG. 12 includes a flow diagram that illustrates an example of the second method 1200 that is associated with determining the degree of deterioration of the electric motor, according to the disclosed technologies. Although the method 1200 is described in combination with the magnetoelectric energy harvester 100 illustrated in FIG. 1, the energy storage device bank 200 illustrated in FIG. 2, and the system 300 illustrated in FIG. 3, one of skill in the art understands, in light of the description herein, that the method 1200 is not limited to being implemented by the magnetoelectric energy harvester 100 illustrated in FIG. 1, the energy storage device bank 200 illustrated in FIG. 2, and the system 300 illustrated in FIG. 3. Rather, the magnetoelectric energy harvester 100 illustrated in FIG. 1, the energy storage device bank 200 illustrated in FIG. 2, and the system 300 illustrated in FIG. 3 are examples of a magnetoelectric energy harvester, an energy storage device bank, and a system that may be used to implement the method 1200. Additionally, although the method 1200 is illustrated as a generally serial process, various aspects of the method 1200 may be able to be executed in parallel.

In FIG. 12, in the method 1200, at an operation 1202, for example, the motor analysis module 312 can receive, from a current sensing device, a measure of an amount of current that flows through an electrode of a power card package of a power control unit associated with the electric motor. Such a measure of the amount of current that flows through the electrode can be indicative of a degree of deterioration of the electric motor.

At an operation 1204, for example, the motor analysis module 312 can determine, based on the measure of the amount of current, the degree of deterioration of the electric motor.

At an operation 1206, for example, the communications module 314 can cause a message to be transmitted. The message can include information about the measure of the amount of current.

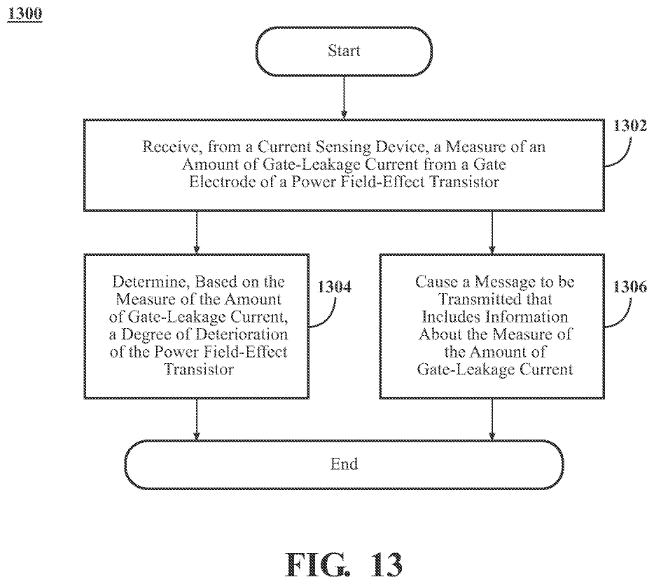

In yet another implementation of yet this other variation of this realization, for example, a degree of deterioration of a power field-effect transistor can be determined according to a method. FIG. 13 includes a flow diagram that illustrates an example of the method 1300 that is associated with determining the degree of deterioration of the power field-effect transistor, according to the disclosed technologies. Although the method 1300 is described in combination with the magnetoelectric energy harvester 100 illustrated in FIG. 1, the energy storage device bank 200 illustrated in FIG. 2, and the system 300 illustrated in FIG. 3, one of skill in the art understands, in light of the description herein, that the method 1300 is not limited to being implemented by the magnetoelectric energy harvester 100 illustrated in FIG. 1, the energy storage device bank 200 illustrated in FIG. 2, and the system 300 illustrated in FIG. 3. Rather, the magnetoelectric energy harvester 100 illustrated in FIG. 1, the energy storage device bank 200 illustrated in FIG. 2, and the system 300 illustrated in FIG. 3 are examples of a magnetoelectric energy harvester, an energy storage device bank, and a system that may be used to implement the method 1300. Additionally, although the method 1300 is illustrated as a generally serial process, various aspects of the method 1300 may be able to be executed in parallel.

In FIG. 13, in the method 1300, at an operation 1302, for example, the motor analysis module 312 can receive, from a current sensing device, a measure of an amount of gate-leakage current from a gate electrode of a power field-effect transistor. Such a measure of the amount of the gate-leakage current from the gate electrode of the power field-effect transistor can be indicative of a degree of deterioration of the power field-effect transistor.

At an operation 1304, for example, the motor analysis module 312 can determine, based on the measure of the amount of gate-leakage current, the degree of deterioration of the power field-effect transistor.

At an operation 1306, for example, the communications module 314 can cause a message to be transmitted. The message can include information about the measure of the amount of gate-leakage current.

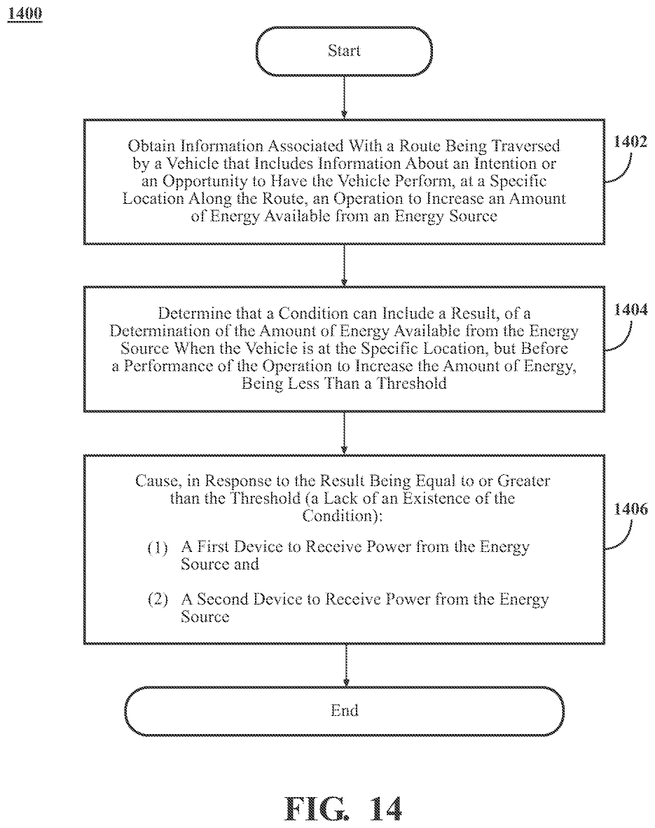

In still another implementation of this realization, for example, storage of energy between the energy source 228 and the energy storage device bank 200 can be managed according to a method. FIG. 14 includes a flow diagram that illustrates an example of the method 1400 that is associated with managing a storage of energy between the energy source 228 and the energy storage device bank 200, according to the disclosed technologies. Although the method 1400 is described in combination with the magnetoelectric energy harvester 100 illustrated in FIG. 1, the energy storage device bank 200 illustrated in FIG. 2, and the system 300 illustrated in FIG. 3, one of skill in the art understands, in light of the description herein, that the method 1400 is not limited to being implemented by the magnetoelectric energy harvester 100 illustrated in FIG. 1, the energy storage device bank 200 illustrated in FIG. 2, and the system 300 illustrated in FIG. 3. Rather, the magnetoelectric energy harvester 100 illustrated in FIG. 1, the energy storage device bank 200 illustrated in FIG. 2, and the system 300 illustrated in FIG. 3 are examples of a magnetoelectric energy harvester, an energy storage device bank, and a system that may be used to implement the method 1400. Additionally, although the method 1400 is illustrated as a generally serial process, various aspects of the method 1400 may be able to be executed in parallel.

In this still other implementation of this realization, for example, the vehicle can include the energy source 228.

In FIG. 14, in the method 1400, at an operation 1402, for example, the route information module 316 can obtain information associated with a route being traversed by the vehicle. The information can include information about one or more of an intention or an opportunity to have the vehicle perform, at a specific location along the route, an operation to increase an amount of energy available from the energy source 228.

Although, in general, the condition can be any condition, in this still other implementation of this realization (i.e., obtaining information about the one or more of the intention or the opportunity to have the vehicle perform, at the specific location along the route, the operation to increase the amount of energy available from the energy source 228), the condition can be specific.

At an operation 1404, for example, the condition determination module 310 can determine that the condition can include a result, of a determination of the amount of energy available from the energy source 228 when the vehicle is at the specific location, but before a performance of the operation to increase the amount of energy, being less than a threshold.

For example, the condition determination module 310 can determine whether the amount of energy available from the energy source 228 when the vehicle is at the specific location, but before a performance of the operation to increase the amount of energy, is greater than the threshold, equal to the threshold, or less than the threshold. The existence of the condition can be that the result of the determination is that the amount of energy available from the energy source 228 is less than the threshold; a lack of the existence of the condition can be that the result of the determination is that the amount of energy available from the energy source 228 is equal to the threshold or greater than the threshold.

At an operation 1406, for example, the controller module 308 can cause, in response to the result, of the determination of the amount of energy available from the energy source 228 when the vehicle is at the specific location, but before the performance of the operation to increase the amount of energy, being equal to the threshold or greater than the threshold: (1) the first device 224 to receive power from the energy source 228 and (2) the second device 226 to receive the power from the energy source 228.

In this manner, because there can be an expectation that the vehicle will perform the operation to increase the amount of energy available from the energy source 228 when the vehicle is at the specific location, use of the energy storage device bank 200 to provide power to the one or more of the first device 224 or the second device 226 can be minimized so that the amount of energy available from the energy storage device bank 200 can be increased while the vehicle traverses to the specific location.

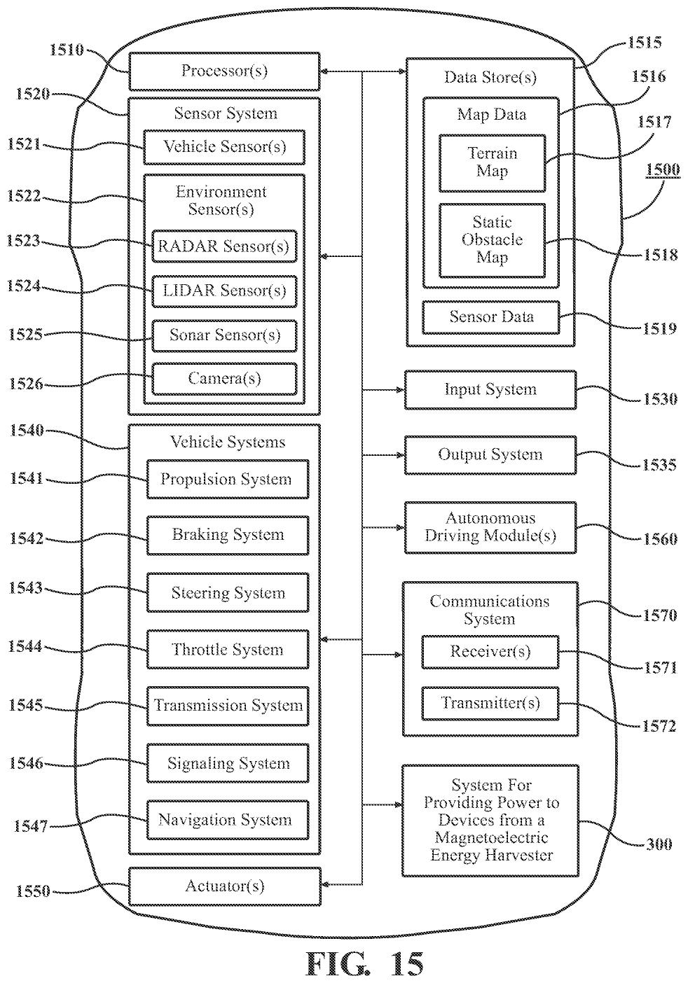

FIG. 15 includes a block diagram that illustrates an example of elements disposed on a vehicle 1500, according to the disclosed technologies. As used herein, a “vehicle” can be any form of powered transport. In one or more implementations, the vehicle 1500 can be an automobile. While arrangements described herein are with respect to automobiles, one of skill in the art understands, in light of the description herein, that embodiments are not limited to automobiles. For example, functions and/or operations of one or more of the second vehicle 739 (illustrated in FIG. 7) or the vehicle 800 (illustrated in FIG. 8) can be realized by the vehicle 1500.

In some embodiments, the vehicle 1500 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 1500 is performed according to inputs received from a user (e.g., human driver). In one or more arrangements, the vehicle 1500 can be a conventional vehicle that is configured to operate in only a manual mode.

In one or more embodiments, the vehicle 1500 can be an automated vehicle. As used herein, “automated vehicle” can refer to a vehicle that operates in an automated mode. As used herein, “automated mode” can refer to navigating and/or maneuvering the vehicle 1500 along a travel route using one or more computing systems to control the vehicle 1500 with minimal or no input from a human driver. In one or more embodiments, the vehicle 1500 can be highly automated or completely automated. In one embodiment, the vehicle 1500 can be configured with one or more semi-automated operational modes in which one or more computing systems perform a portion of the navigation and/or maneuvering of the vehicle along a travel route, and a vehicle operator (i.e., driver) provides inputs to the vehicle 1500 to perform a portion of the navigation and/or maneuvering of the vehicle 1500 along a travel route.

For example, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 1500 can include various elements. The vehicle 1500 can have any combination of the various elements illustrated in FIG. 15. In various embodiments, it may not be necessary for the vehicle 1500 to include all of the elements illustrated in FIG. 15. Furthermore, the vehicle 1500 can have elements in addition to those illustrated in FIG. 15. While the various elements are illustrated in FIG. 15 as being located within the vehicle 1500, one or more of these elements can be located external to the vehicle 1500. Furthermore, the elements illustrated may be physically separated by large distances. For example, as described, one or more components of the disclosed system can be implemented within the vehicle 1500 while other components of the system can be implemented within a cloud-computing environment, as described below. For example, the elements can include one or more processors 1510, one or more data stores 1515, a sensor system 1520, an input system 1530, an output system 1535, vehicle systems 1540, one or more actuators 1550, one or more automated driving modules 1560, a communications system 1570, and the system 300 for providing power to devices from a magnetoelectric energy harvester.

In one or more arrangements, the one or more processors 1510 can be a main processor of the vehicle 1500. For example, the one or more processors 1510 can be an electronic control unit (ECU). For example, functions and/or operations of one or more of the processor 302 (illustrated in FIG. 3) or the processor 868 (illustrated in FIG. 8) can be realized by the one or more processors 1510.

The one or more data stores 1515 can store, for example, one or more types of data. The one or more data stores 1515 can include volatile memory and/or non-volatile memory. For example, functions and/or operations of one or more of the memory 304 or the memory 870 (illustrated in FIG. 8) can be realized by the one or more data stores 1515. Examples of suitable memory for the one or more data stores 1515 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 1515 can be a component of the one or more processors 1510. Additionally or alternatively, the one or more data stores 1515 can be operatively connected to the one or more processors 1510 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation.

In one or more arrangements, the one or more data stores 1515 can store map data 1516. The map data 1516 can include maps of one or more geographic areas. In some instances, the map data 1516 can include information or data on roads, traffic control devices, road markings, structures, features, and/or landmarks in the one or more geographic areas. The map data 1516 can be in any suitable form. In some instances, the map data 1516 can include aerial views of an area. In some instances, the map data 1516 can include ground views of an area, including 360-degree ground views. The map data 1516 can include measurements, dimensions, distances, and/or information for one or more items included in the map data 1516 and/or relative to other items included in the map data 1516. The map data 1516 can include a digital map with information about road geometry. The map data 1516 can be high quality and/or highly detailed.

In one or more arrangements, the map data 1516 can include one or more terrain maps 1517. The one or more terrain maps 1517 can include information about the ground, terrain, roads, surfaces, and/or other features of one or more geographic areas. The one or more terrain maps 1517 can include elevation data of the one or more geographic areas. The map data 1516 can be high quality and/or highly detailed. The one or more terrain maps 1517 can define one or more ground surfaces, which can include paved roads, unpaved roads, land, and other things that define a ground surface.

In one or more arrangements, the map data 1516 can include one or more static obstacle maps 1518. The one or more static obstacle maps 1518 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 1518 can have location data, size data, dimension data, material data, and/or other data associated with them. The one or more static obstacle maps 1518 can include measurements, dimensions, distances, and/or information for one or more static obstacles. The one or more static obstacle maps 1518 can be high quality and/or highly detailed. The one or more static obstacle maps 1518 can be updated to reflect changes within a mapped area.

In one or more arrangements, the one or more data stores 1515 can store sensor data 1519. As used herein, “sensor data” can refer to any information about the sensors with which the vehicle 1500 can be equipped including the capabilities of and other information about such sensors. The sensor data 1519 can relate to one or more sensors of the sensor system 1520. For example, in one or more arrangements, the sensor data 1519 can include information about one or more lidar sensors 1524 of the sensor system 1520.

In some arrangements, at least a portion of the map data 1516 and/or the sensor data 1519 can be located in one or more data stores 1515 that are located onboard the vehicle 1500. Additionally or alternatively, at least a portion of the map data 1516 and/or the sensor data 1519 can be located in one or more data stores 1515 that are located remotely from the vehicle 1500.

The sensor system 1520 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 1520 includes a plurality of sensors, the sensors can work independently from each other. Alternatively, two or more of the sensors can work in combination with each other. In such a case, the two or more sensors can form a sensor network. The sensor system 1520 and/or the one or more sensors can be operatively connected to the one or more processors 1510, the one or more data stores 1515, and/or another element of the vehicle 1500 (including any of the elements illustrated in FIG. 15). The sensor system 1520 can acquire data of at least a portion of the external environment of the vehicle 1500 (e.g., nearby vehicles). The sensor system 1520 can include any suitable type of sensor. Various examples of different types of sensors are described herein. However, one of skill in the art understands that the embodiments are not limited to the particular sensors described herein.

The sensor system 1520 can include one or more vehicle sensors 1521. The one or more vehicle sensors 1521 can detect, determine, and/or sense information about the vehicle 1500 itself. In one or more arrangements, the one or more vehicle sensors 1521 can be configured to detect and/or sense position and orientation changes of the vehicle 1500 such as, for example, based on inertial acceleration. In one or more arrangements, the one or more vehicle sensors 1521 can include one or more accelerometers, one or more gyroscopes, an inertial measurement unit (IMU), a dead-reckoning system, a global navigation satellite system (GNSS), a global positioning system (GPS), a navigation system 1547, and/or other suitable sensors. The one or more vehicle sensors 1521 can be configured to detect and/or sense one or more characteristics of the vehicle 1500. In one or more arrangements, the one or more vehicle sensors 1521 can include a speedometer to determine a current speed of the vehicle 1500. For example, functions and/or operations of one or more of the first current sensing device 830 (illustrated in FIG. 8), the second current sensing device 832 (illustrated in FIG. 8), the first power alignment sensing device 834 (illustrated in FIG. 8), or the proximity sensing device 836 (illustrated in FIG. 8) can be realized by the one or more vehicle sensors 1521.

Additionally or alternatively, the sensor system 1520 can include one or more environment sensors 1522 configured to acquire and/or sense driving environment data. As used herein, “driving environment data” can include data or information about the external environment in which a vehicle is located or one or more portions thereof. For example, the one or more environment sensors 1522 can be configured to detect, quantify, and/or sense obstacles in at least a portion of the external environment of the vehicle 1500 and/or information/data about such obstacles. Such obstacles may be stationary objects and/or dynamic objects. The one or more environment sensors 1522 can be configured to detect, measure, quantify, and/or sense other things in the external environment of the vehicle 1500 such as, for example, lane markers, signs, traffic lights, traffic signs, lane lines, crosswalks, curbs proximate the vehicle 1500, off-road objects, etc.

Various examples of sensors of the sensor system 1520 are described herein. The example sensors may be part of the one or more vehicle sensors 1521 and/or the one or more environment sensors 1522. However, one of skill in the art understands that the embodiments are not limited to the particular sensors described.

In one or more arrangements, the one or more environment sensors 1522 can include one or more radar sensors 1523, one or more lidar sensors 1524, one or more sonar sensors 1525, and/or one more cameras 1526. In one or more arrangements, the one or more cameras 1526 can be one or more high dynamic range (HDR) cameras or one or more infrared (IR) cameras. For example, the one or more cameras 1526 can be used to record a reality of a state of an item of information that can appear in the digital map. For example, functions and/or operations of the ranging device 872 (illustrated in FIG. 8) can be realized by one or more of the one or more radar sensors 1523, the one or more lidar sensors 1524, or the one or more sonar sensors 1525. For example, functions and/or operations of the imaging device 838 (e.g., the camera) (illustrated in FIG. 8) can be realized by the one or more cameras 1526.

The input system 1530 can include any device, component, system, element, arrangement, or groups thereof that enable information/data to be entered into a machine. The input system 1530 can receive an input from a vehicle passenger (e.g., a driver or a passenger). The output system 1535 can include any device, component, system, element, arrangement, or groups thereof that enable information/data to be presented to a vehicle passenger (e.g., a driver or a passenger).

Various examples of the one or more vehicle systems 1540 are illustrated in FIG. 15. However, one of skill in the art understands that the vehicle 1500 can include more, fewer, or different vehicle systems. Although particular vehicle systems can be separately defined, each or any of the systems or portions thereof may be otherwise combined or segregated via hardware and/or software within the vehicle 1500. For example, the one or more vehicle systems 1540 can include a propulsion system 1541, a braking system 1542, a steering system 1543, a throttle system 1544, a transmission system 1545, a signaling system 1546, and/or the navigation system 1547. Each of these systems can include one or more devices, components, and/or a combination thereof, now known or later developed.

The navigation system 1547 can include one or more devices, applications, and/or combinations thereof, now known or later developed, configured to determine the geographic location of the vehicle 1500 and/or to determine a travel route for the vehicle 1500. The navigation system 1547 can include one or more mapping applications to determine a travel route for the vehicle 1500. The navigation system 1547 can include a global positioning system, a local positioning system, a geolocation system, and/or a combination thereof.

The one or more actuators 1550 can be any element or combination of elements operable to modify, adjust, and/or alter one or more of the vehicle systems 1540 or components thereof responsive to receiving signals or other inputs from the one or more processors 1510. Any suitable actuator can be used. For example, the one or more actuators 1550 can include motors, pneumatic actuators, hydraulic pistons, relays, solenoids, and/or piezoelectric actuators.

The one or more processors 1510 can be operatively connected to communicate with the various vehicle systems 1540 and/or individual components thereof. For example, the one or more processors 1510 can be in communication to send and/or receive information from the various vehicle systems 1540 to control the movement, speed, maneuvering, heading, direction, etc. of the vehicle 1500. The one or more processors 1510 may control some or all of these vehicle systems 1540.

The one or more processors 1510 may be operable to control the navigation and/or maneuvering of the vehicle 1500 by controlling one or more of the vehicle systems 1540 and/or components thereof. The one or more processors 1510 can cause the vehicle 1500 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 1570 can include one or more receivers 1571 and/or one or more transmitters 1572. The communications system 1570 can receive and transmit one or more messages through one or more wireless communications channels. For example, functions and/or operations of one or more of the receiver 744 (illustrated in FIG. 7) or the receiver 842 (illustrated in FIG. 8) can be realized by the one or more receivers 1571. For example, functions and/or operations of one or more of the transmitter 743 (illustrated in FIG. 7) or the transmitter 840 (illustrated in FIG. 8) can be realized by the one or more transmitters 1572. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 570 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies.

Moreover, the one or more processors 1510, the one or more data stores 1515, and the communications system 1570 can be configured to one or more of form a micro cloud, participate as a member of a micro cloud, or perform a function of a leader of a mobile micro cloud. A micro cloud can be characterized by a distribution, among members of the micro cloud, of one or more of one or more computing resources or one or more data storage resources in order to collaborate on executing operations. The members can include at least connected vehicles.

The vehicle 1500 can include one or more modules, at least some of which are described herein. The modules can be implemented as computer-readable program code that, when executed by the one or more processors 1510, implement one or more of the various processes described herein. One or more of the modules can be a component of the one or more processors 1510. Additionally or alternatively, one or more of the modules can be executed on and/or distributed among other processing systems to which the one or more processors 1510 can be operatively connected. The modules can include instructions (e.g., program logic) executable by the one or more processors 1510. Additionally or alternatively, the one or more data store 1515 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 1500 can include one or more automated driving modules 1560. The one or more automated driving modules 1560 can be configured to receive data from the sensor system 1520 and/or any other type of system capable of capturing information relating to the vehicle 1500 and/or the external environment of the vehicle 1500. In one or more arrangements, the one or more automated driving modules 1560 can use such data to generate one or more driving scene models. The one or more automated driving modules 1560 can determine position and velocity of the vehicle 1500. The one or more automated driving modules 1560 can determine the location of obstacles, obstacles, or other environmental features including traffic signs, trees, shrubs, neighboring vehicles, pedestrians, etc.

The one or more automated driving modules 1560 can be configured to receive and/or determine location information for obstacles within the external environment of the vehicle 1500 for use by the one or more processors 1510 and/or one or more of the modules described herein to estimate position and orientation of the vehicle 1500, vehicle position in global coordinates based on signals from a plurality of satellites, or any other data and/or signals that could be used to determine the current state of the vehicle 1500 or determine the position of the vehicle 1500 with respect to its environment for use in either creating a map or determining the position of the vehicle 1500 in respect to map data.

The one or more automated driving modules 1560 can be configured to determine one or more travel paths, current automated driving maneuvers for the vehicle 1500, future automated driving maneuvers and/or modifications to current automated driving maneuvers based on data acquired by the sensor system 1520, driving scene models, and/or data from any other suitable source such as determinations from the sensor data 1519. As used herein, “driving maneuver” can refer to one or more actions that affect the movement of a vehicle. Examples of driving maneuvers include: accelerating, decelerating, braking, turning, moving in a lateral direction of the vehicle 1500, changing travel lanes, merging into a travel lane, and/or reversing, just to name a few possibilities. The one or more automated driving modules 1560 can be configured to implement determined driving maneuvers. The one or more automated driving modules 1560 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 1560 can be configured to execute various vehicle functions and/or to transmit data to, receive data from, interact with, and/or control the vehicle 1500 or one or more systems thereof (e.g., one or more of vehicle systems 1540). For example, functions and/or operations of an automotive navigation system can be realized by the one or more automated driving modules 1560.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-9, 10A-10C, and 11-15, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having.” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
a rate analysis module including instructions that, when executed by the processor, cause the processor to determine a rate at which an energy storage device bank stores energy received from a magnetoelectric energy harvester; and
a controller module including instructions that, when executed by the processor, cause the processor to cause, in response to an existence of a condition and the rate being:
greater than a power consumption rate of a first device, the first device to receive power from the energy storage device bank; and
greater than a power consumption rate of a second device, but less than the power consumption rate of the first device, the second device to receive the power from the energy storage device bank.

2. The system of claim 1, wherein the controller module further includes instructions to cause:
in response to the rate being less than the power consumption rate of the second device:
the first device to receive power from an energy source; and
the second device to receive the power from the energy source;
in response to the rate being greater than the power consumption rate of the first device:
the second device to receive the power from the energy source;
in response to the rate being greater than the power consumption rate of the second device, but less than the power consumption rate of the first device:
the first device to receive the power from the energy source;
in response to the rate being greater than a sum of the power consumption rate of the first device and the power consumption rate of the second device:
the first device to receive the power from the energy storage device bank; and
the second device to receive the power from the energy storage device bank; and
in response to the rate being greater than the sum of the power consumption rate of the first device and the power consumption rate of the second device:
the energy source to receive the power from the energy storage device bank.

3. The system of claim 1, wherein:
the controller module further includes instructions to cause a first energy storage device, of the energy storage device bank, to be configured to store the energy received from the magnetoelectric energy harvester;
the rate analysis module further includes instructions to determine that an amount of energy stored by the first energy storage device is at a capacity of the first energy storage device; and
the controller module further includes instructions to cause, in response to a determination that the amount of energy stored by the first energy storage device is at the capacity of the first energy storage device:
a second energy storage device, of the energy storage device bank, to be configured to store the energy received from the magnetoelectric energy harvester; and
the first energy storage device to be configured to cease storing the energy received from the magnetoelectric energy harvester.

4. The system of claim 1, wherein:
the first device comprises one of a sensing device and a communications device;
the second device comprises one of the sensing device and the communications device; and
the second device is different from the first device.

5. The system of claim 4, wherein the sensing device is communicably connected to the communications device.

6. The system of claim 4, wherein:
the sensing device comprises at least one of a humidity sensing device, a vibration sensing device, a temperature sensing device, a water leak sensing device, an uninterrupted power supply monitoring sensing device, a current sensing device, a power alignment sensing device, a proximity sensing device, an imaging device, or a ranging device; and
the communications device comprises at least one of a transmitter, a receiver, or a transceiver.

7. The system of claim 6, wherein at least one of:
the transmitter comprises a magnetoelectric energy transmitter, or
the receiver comprises a magnetoelectric energy receiver.

8. The system of claim 4, wherein:
the memory further stores a condition determination module,
if the first device comprises the communications device, then the condition determination module includes instructions that, when executed by the processor, cause the processor to determine that the condition comprises the communications device needing to be in a state to perform a communication,
if the second device comprises the communications device, then the condition determination module includes instructions that, when executed by the processor, cause the processor to determine that the condition comprises the communications device needing to be in a state to perform a communication,
if the first device comprises the sensing device, then the condition determination module includes instructions that, when executed by the processor, cause the processor to determine that the condition comprises the sensing device needing to be in a state to perform a sensing operation, and
if the second device comprises the sensing device, then the condition determination module includes instructions that, when executed by the processor, cause the processor to determine that the condition comprises the sensing device needing to be in a state to perform a sensing operation.

9. The system of claim 1, wherein:
at least one of the processor, the memory, the energy storage device bank, the magnetoelectric energy harvester, the first device, or the second device is disposed on a vehicle,
the vehicle comprises a wireless power receiving coil configured to produce, in a presence of a magnetic field, power in an alternating current form, and
the magnetoelectric energy harvester is disposed on the vehicle in a vicinity of the wireless power receiving coil.

10. The system of claim 9, wherein at least one of the first device or the second device comprises a power alignment sensing device configured to sense a degree of alignment between the wireless power receiving coil and a wireless power transmitting coil.

11. The system of claim 1, wherein:
at least one of the processor, the memory, the energy storage device bank, the magnetoelectric energy harvester, the first device, or the second device is disposed on a vehicle, and
the magnetoelectric energy harvester is disposed on the vehicle at a position to be exposed to radio frequency waves associated with communications among at least one of vehicles or between one vehicle and another communications device.

12. The system of claim 1, wherein:
at least one of the processor, the memory, the energy storage device bank, the magnetoelectric energy harvester, the first device, or the second device is disposed on a vehicle,
the vehicle comprises an energy source, an inverter, power cables, and an electric motor,
the energy source is configured to produce power in a direct current form,
the inverter is configured to convert the power in the direct current form to power in an alternating current form,
the power cables are configured to convey the power in the alternating current form from the inverter to the electric motor,
the electric motor is configured to receive the power in the alternating current form and to produce a propulsion force for the vehicle, and
the magnetoelectric energy harvester is disposed on the vehicle in a vicinity of the power cables.

13. The system of claim 12, wherein:
the rate analysis module further includes instructions to determine, over a duration of time, a change in the rate at which the energy storage device bank stores energy received from the magnetoelectric energy harvester, the duration of time being longer than a duration of a cycle of the power in the alternating current form,
the memory further stores a motor analysis module, the motor analysis module including instructions that, when executed by the processor, cause the processor to determine, based on the change in the rate over the duration of time, a change in an amount of current that flows through the power cables, and
at least one of:
the motor analysis module further includes instructions to determine, based on the change in the amount of current, a degree of deterioration of the electric motor, or
the memory further stores a communications module, the communications module including instructions that, when executed by the processor, cause the processor to cause a message to be transmitted, the message including information about the change in the amount of current.

14. The system of claim 12, wherein:
at least one of the first device or the second device comprises a current sensing device,
the memory further stores a motor analysis module, the motor analysis module including instructions that, when executed by the processor, cause the processor to receive, from the current sensing device, a measure of an amount of current that flows through an electrode of a power card package of a power control unit associated with the electric motor, and
at least one of:
the motor analysis module further includes instructions to determine, based on the measure of the amount of current, a degree of deterioration of the electric motor, or
the memory further stores a communications module, the communications module including instructions that, when executed by the processor, cause the processor to cause a message to be transmitted, the message including information about the measure of the amount of current.

15. The system of claim 12, wherein:
at least one of the first device or the second device comprises a current sensing device,
the memory further stores a motor analysis module, the motor analysis module including instructions that, when executed by the processor, cause the processor to receive, from the current sensing device, a measure of an amount of gate-leakage current from a gate electrode of a power field-effect transistor, and
at least one of:
the motor analysis module further includes instructions to determine, based on the measure of the amount of gate-leakage current, a degree of deterioration of the power field-effect transistor, or
the memory further stores a communications module, the communications module including instructions that, when executed by the processor, cause the processor to cause a message to be transmitted, the message including information about the measure of the amount of gate-leakage current.

16. The system of claim 1, wherein:
at least one of the processor, the memory, the energy storage device bank, the magnetoelectric energy harvester, the first device, or the second device is disposed on a vehicle,
the vehicle comprises an energy source,
the memory further stores a route information module, the route information module including instructions that, when executed by the processor, cause the processor to obtain information associated with a route being traversed by the vehicle,
the information includes information about at least one of an intention or an opportunity to have the vehicle perform, at a specific location along the route, an operation to increase an amount of energy available from the energy source,
the memory further stores a condition determination module, the condition determination module including instructions that, when executed by the processor, cause the processor to determine that the condition comprises a result, of a determination of the amount of energy available from the energy source when the vehicle is at the specific location, but before a performance of the operation to increase the amount of energy, being less than a threshold, and
the controller module further includes instructions to cause, in response to the result, of the determination of the amount of energy available from the energy source when the vehicle is at the specific location, but before the performance of the operation to increase the amount of energy, being greater than the threshold:
the first device to receive power from the energy source; and
the second device to receive the power from the energy source.

17. The system of claim 1, wherein at least one of the processor, the memory, the energy storage device bank, the magnetoelectric energy harvester, the first device, or the second device is disposed in a building.

18. A method, comprising:
determining, by a processor, a rate at which an energy storage device bank stores energy received from a magnetoelectric energy harvester; and
causing, by the processor, in response to an existence of a condition and the rate being:
greater than a power consumption rate of a first device, the first device to receive power from the energy storage device bank; and
greater than a power consumption rate of a second device, but less than the power consumption rate of the first device, the second device to receive the power from the energy storage device bank.

19. The method of claim 18, further comprising:
causing, by the processor, a first energy storage device, of the energy storage device bank, to be configured to store the energy received from the magnetoelectric energy harvester;
determining, by the processor, that an amount of energy stored by the first energy storage device is at a capacity of the first energy storage device; and
causing, by the processor in response to a determination that the amount of energy stored by the first energy storage device is at the capacity of the first energy storage device:
a second energy storage device, of the energy storage device bank, to be configured to store the energy received from the magnetoelectric energy harvester; and
the first energy storage device to be configured to cease storing the energy received from the magnetoelectric energy harvester.

20. A non-transitory computer-readable medium for providing power to devices from a magnetoelectric energy harvester, the non-transitory computer-readable medium including instructions that, when executed by one or more processors, cause the one or more processors to:
determine a rate at which an energy storage device bank stores energy received from the magnetoelectric energy harvester; and
cause, in response to an existence of a condition and the rate being:
greater than a power consumption rate of a first device, the first device to receive power from the energy storage device bank; and
greater than a power consumption rate of a second device, but less than the power consumption rate of the first device, the second device to receive the power from the energy storage device bank.
